(19) United States
(12) Patent Application Publication
(10) Pub. No.: US 2007/0097108 A1
(43) Pub. Date: May 3, 2007

(54) Elastic fiber optic image guide

(76) Inventor: Donald R. Brewer, Richardson, TX (US)

Correspondence Address: KRIEG DEVAULT LLP, ONE INDIANA SQUARE, SUITE 2800, INDIANAPOLIS, IN, 46204-2079, US

(21) Appl. No.: 11/589,380

(22) Filed: Oct. 30, 2006

Related U.S. Application Data
(60) Provisional application No. 60/731,090, filed on Oct. 28, 2005.

(51) Int. Cl. G09G 5/00

(52) U.S. Cl. 345/204

(57) ABSTRACT

There is disclosed a mobile consumer electronic device comprising a display capable of providing information at an external display surface. The device further includes an elastic fiber optic image guide extending between a first end and a second end. The first end of the elastic fiber optic image guide is optically coupled to the external display surface. The second end of the elastic fiber optic image guide having a first configuration in a first mode and a second configuration in a second mode. The second end may be rotated and/or enlarged in the second mode when compared to the first mode.

This application claims the benefit of U.S. Provisional Application Ser. No. 60/731,090 entitled “Elastic Fiber Optic Image Guide” filed on Oct. 28, 2005.

### BACKGROUND OF THE INVENTION

Currently there are a wide assortment of consumer electronic devices such as mobile phones, MP3 players, and digital wrist watches that include an information display, such as a liquid crystal display (“LCD”), as the main visual interface to the device. In many such product applications the information display is a prominent design element as well as the only way for a user to interact and control the functions of the mobile device. The proliferation of inexpensive consumer electronics has commoditized the appearance of a typical black on grey liquid crystal display, and even color active matrix displays are now found in a wide assortment of mobile phones, digital cameras, mobile game devices, and MP3 or video players. Within the different categories of consumer electronic devices many manufacturers have products that are substantially equivalent in both specifications and functions to those of other manufacturers. Thus, manufacturers are constantly searching for new ways to differentiate the design and appearance of their device in any way from other products, particularly more inexpensive products.

Optical fibers are typically either glass or plastic optic threads that are capable of transmitting light along their length, preferably with minimal loss based on the optic principles of Snell's law and internal reflection. Fiber optics are now commonly used both for data transmission as well as transmitting either light or image information. Fiber optic image guides are now common in a number of high dollar value applications in the market place. In some applications, a fiber optic face plate comprises thousands of glass fibers arranged parallel to one another in a coherent bundle, and fused together so that it is hermetically tight. Thus, the fiber optic faceplate can transfer an image from one plane to another plane. Some industrial applications use fused coherent fiber optics bundles for image transfer; such as in the fiber optics faceplates used on some cathode ray rubes (CRTs) to “flatten” the image.

The use of fiber optic faceplates with information displays is described in U.S. Pat. No. 4,349,817 to Hoffman et al. with the use of a dynamic scattering liquid crystal display, as well as in U.S. Pat. No. 4,183,630 to Funada, U.S. Pat. No. 5,035,490 to Hubby, Jr. and U.S. Pat. No. 5,181,130 to Hubby, Jr. in combination with a liquid crystal display utilizing at least one polarizer, most typical of the type of liquid crystal displays found in consumer products today. In these early patents the fiber optic faceplate is used to transfer an image from the liquid crystal display image plane up to the outer plane of the fiber optic faceplate as much as 1.1 mm away. The focus of the disclosures of these patents, however, is to improve the image quality of the underlying liquid crystal display by increasing the light incident on the liquid crystal display, removing the ghosting effects, and improving off-axis viewing.

Although discussed in the two patents to Hubby, Jr. filed approximately 15 years ago, fiber optic faceplates in combination with information displays have not been accepted in the market to any significant degree. This is at least in part due to market considerations wherein there is a tradeoff between price and acceptable display functionality. Although the image quality of liquid crystal displays can be improved as discussed in the patents to Hubby, Jr., the method discussed therein (which often involves replacing the top glass substrate layer with a fiber optic faceplate) is generally not considered commercially feasible due to the production techniques and materials. As taught they offer little to no significant improvement in image quality that might justify the added cost of the external fiber optic faceplate.

Consumer product manufacturers often find that the negative display issues with liquid crystal displays, such as poor reflectance and limited off-axis viewing, are acceptable at the price level of said displays. As discussed in U.S. Pat. No. 4,183,630 to Funada et al., one could couple a fiber optic faceplate to the top surface of a conventionally made reflective liquid crystal display with top and bottom glass substrates and outer top and bottom polarizers, but such a configuration typically has less optical performance than if the fiber optic faceplate is actually the top substrate of the liquid crystal display itself. Since the optical performance of liquid crystal displays was a major issue through the late 1970's into the early 1990's, none of these early patents considered the potential overall design possibilities that are possible when the fiber optic image guides are used unconventionally with a display.

The numerous information display technologies available in the market today generally present only a flat two-dimensional display format. Some patents detail the use of fiber optic faceplates coupled with cathode ray tube (CRT) displays to convert the typical curved CRT display output to a flat, planar display image. Visually this flat display appearance has become commoditized and, as mentioned previously, companies are seeking new ways to differentiate the design of their products.

### SUMMARY OF THE INVENTION

In one embodiment of the present invention there is disclosed a mobile consumer electronic device comprising a display capable of providing information at an external display surface. The device further includes an elastic fiber optic image guide extending between a first face and a second face. The first face of the elastic fiber optic image guide is optically coupled to the external display surface. The second face of the elastic fiber optic image guide having a first state with a first area and an expanded second state with a second area. The second area is larger than the first area.

In another embodiment of the present invention there is an elastic fiber optic image guide or bundle. At least one, if not both, of the core and cladding materials utilized in the individual fibers is made of a material that is elastic. The elastic material preferably has a glass transition temperature lower than room temperature (or the temperature of typical usage conditions). A fiber optic image guide constructed with such elastic materials may have a first end and a second end. A portion or the entirety of the second end might be altered. A stretching deformation yields larger diameter individual optical fibers at the second end versus the diameters of the optical fibers on the opposite side of the image guide, thus producing a magnification. When the mechanical force is removed the elastic image guide will at least partially, if not substantially entirely, return to a non-magnified state. The elastic image guide could also be deformed by having a portion of it twisted to produce a twisted image. The fiber optic image guide made of non-rigid and/or elastic materials preferably has the ability to deform when a mechanical force is introduced and at least partially, if not entirely, return to an original state when the force is removed.

In one embodiment of the present invention there is an apparatus comprising a fiber optic image guide comprising a plurality of optical fibers. Each optical fiber comprises both a core material and a cladding material. At least one of the core material and the cladding material is elastic at room temperature.

In one aspect of the embodiment both the core material and the cladding material are elastic at room temperature.

In another aspect of the embodiment both the core material and the cladding material have a glass transition temperature less than forty degrees Fahrenheit.

In another aspect of the embodiment the at least one of the core material and the cladding material is selected from a group consisting of a polymer, thermoplastic elastomer, fluoropolymer, rubber or silicone.

In another aspect of the embodiment the at least one of the core material and the cladding material has a glass transition temperature at or below room temperature.

In another aspect of the embodiment at least a portion of the plurality of optical fibers extend between an input face and an output face of the fiber optic image guide. The fiber optic image guide has a first mode in which no force is applied to the output face. The fiber optic image guide has a second mode in which the output face of the fiber optic image guide is at least partially elastically deformed by a force. The second output image formed on the output face in the second mode is optically different than a first output image formed on the output face in the first mode.

In another aspect of the embodiment the first output image is substantially the same as an input image present at the input face.

In another aspect of the embodiment at least a portion of the second output image is magnified compared to a corresponding portion of the first output image.

In another aspect of the embodiment a surface area of one of the plurality of optical fibers at the output face in the second mode is greater than the surface area of the one of the plurality of optical fibers at the output face in the first mode.

In another aspect of the embodiment at least a portion of the elastic fiber optic image guide is substantially tapered in the second mode.

In another aspect of the embodiment at least a portion of the output image in the second mode is rotated with respect to at least a portion of the input image present at the input face.

In another aspect of the embodiment the plurality of optical fibers are substantially circular in cross-section in the first mode.

In another embodiment of the present invention there is a fiber optic image guide comprising a plurality of optical fibers extending between an input face and an output face. Each optical fiber comprising a core material and a cladding material. At least one of the core material and the cladding material is not rigid.

In one aspect of the embodiment at least a portion of the plurality of optical fibers extend between an input face and an output face of the fiber optic image guide. The fiber optic image guide has a first mode in which no force is applied to the output face and a second mode in which the output face of the fiber optic image guide is at least partially elastically deformed. A second output image formed on the output face in the second mode is optically different than a first output image formed on the output face in the first mode. The first output image is substantially the same as an input image present at the input face.

In another aspect of the embodiment the at least one of the core material and the cladding material has a glass transition temperature less than forty degrees Fahrenheit.

In another aspect of the embodiment at least a portion of the second output image is magnified compared to a corresponding portion of the first output image.

In another aspect of the embodiment at least a portion of the second output image is rotated compared to the first output image.

In another embodiment of the present invention there is an apparatus comprising an information display having an external display surface. The apparatus further comprises a fiber optic image guide having a plurality of optical fibers extending between an input face and an output face. The input face of the fiber optic image guide is optically coupled to the external display surface of the information display. The output face is at least partially elastically deformable from a first state to a second state. The output face has a larger surface area in the second state than in the first state.

In one aspect of the embodiment the fiber optic image guide comprises a plurality of optical fibers. Each fiber comprises a core material and a cladding material. At least one of the core material and the cladding material has a glass transition temperature below room temperature.

In another aspect of the embodiment the information display is a liquid crystal display.

In another aspect of the embodiment the liquid crystal display is selected from a group consisting of: twisted-nematic, super twisted nematic, active matrix, liquid crystal on silicon, or an organic light emitting polymer display.

In another aspect of the embodiment the information display and fiber optic image guide are part of a mobile device. The output face of the fiber optic image guide provides a first non-magnified image of the information display in the first state. The output face of the fiber optic image guide provides a second at least partially enlarged image of the information display in the second state.

In another aspect of the embodiment the mobile device is a mobile phone.

In another aspect of the embodiment the mobile device is a MP3 player.

In another aspect of the embodiment the mobile device is a watch.

In another aspect of the embodiment the mobile device is a digital camcorder or digital camera.

In another aspect of the embodiment the mobile device is an electronic dictionary.

In another aspect of the embodiment the mobile device is a video player.

In another aspect of the embodiment the mobile device is a mobile game device.

In another aspect of the embodiment both the core material and the cladding material are elastic at room temperature.

In another aspect of the embodiment both the core material and the cladding material have a glass transition temperature less than thirty-fifty degrees Fahrenheit.

In another aspect of the embodiment the at least one of the core material and the cladding material is selected from a group consisting of a polymer, thermoplastic elastomer, fluoropolymer, rubber or silicone.

In another aspect of the embodiment the apparatus has a first mode in which no force is applied to the output face. The apparatus also has a second mode in which the output face of the fiber optic image guide is at least deformed by a force. A second output image formed on the output face in the second mode is magnified when compared to a first output image formed on the output face in the first mode.

In another aspect of the embodiment the first output image in the first mode is substantially the same as an input image present at the input face.

In another aspect of the embodiment at least a portion of the output image in the second mode is also rotated with respect to a corresponding portion of the output image in the first mode.

In another aspect of the embodiment the apparatus further comprises a substantially transparent film affixed to at least a portion of the output face of the fiber optic image guide.

In another aspect of the embodiment the film includes varying optical properties to provide more uniform magnification.

In another aspect of the embodiment the plurality of optical fibers have varying elasticity to compensate for distortion in the second mode and provide more uniform magnification in the second mode.

In another aspect of the embodiment the information display is a liquid crystal display, and the brightness of a light source of the liquid crystal display is increased when the output face is in the second state.

In another embodiment of the present invention there is a mobile device comprising a power source and a microprocessor electrically connected to the power source. The mobile device further comprises an information display with an external display surface, the information display being electrically connected to the microprocessor. The mobile device further includes a fiber optic image guide having a plurality of optical fibers extending between an input face and an output face. The input face of the fiber optic image guide is optically coupled to the external display surface of the information display. The output face of the fiber optic image guide is deformable from a first state to a second state.

In one aspect of the embodiment the deformation of at least a portion of the output face from the first state to the second state results in increased surface area of the output face in the second state. The information display generates an input image to the input face of the fiber optic image guide. A second output image at the output face of the fiber optic image guide is at least partially magnified in the second state when compared to a first output image in the first state.

In another aspect of the embodiment the second output image produced at the output face of the fiber optic image guide in the second state includes non-uniform magnification. The microprocessor controls the information display to generate an altered input image so that the second output image at the output face of the fiber optic image guide appears to have a more uniform magnification.

In another aspect of the embodiment the information display generates an altered input image that is configured to at least partially counter an aberration created by the fiber optic image guide in its second state.

In another aspect of the embodiment the altered input image includes a counter-distortion relative to the input image in the first state that is configured to least partially counter a distortion in the fiber optic image guide in the second state.

In another aspect of the embodiment the distortion results from non-uniform magnification.

In another aspect of the embodiment the first output image is substantially the same as an input image present at the input face in the first state.

In another aspect of the embodiment the information display is a liquid crystal display.

In another aspect of the embodiment the liquid crystal display is selected from a group consisting of: twisted-nematic, super twisted nematic, active matrix, liquid crystal on silicon, or an organic light emitting polymer display.

In another aspect of the embodiment the mobile device is a mobile phone.

In another aspect of the embodiment the mobile device is a MP3 player.

In another aspect of the embodiment the mobile device is a watch.

In another aspect of the embodiment the mobile device is a digital camcorder or digital camera.

In another aspect of the embodiment the mobile device is an electronic dictionary.

In another aspect of the embodiment the mobile device is a video player.

In another aspect of the embodiment the mobile device is a mobile game device.

In another aspect of the embodiment each of the plurality of optical fibers comprises a core material and a cladding material. At least one of the core material and the cladding material is elastic at room temperature.

In another aspect of the embodiment both the core material and the cladding material are elastic at room temperature.

In another aspect of the embodiment the cladding material is colored black or dark to improve contrast of an image displayed on the output face.

In another aspect of the embodiment both the core material and the cladding material have a glass transition temperature less than forty degrees Fahrenheit.

In another aspect of the embodiment the at least one of the core material and the cladding material is selected from a group consisting of a polymer, thermoplastic elastomer, fluoropolymer, rubber or silicone.

In another aspect of the embodiment at least a portion of the second output image is also rotated with respect to a corresponding portion of the first output image.

In another aspect of the embodiment the information display is a liquid crystal display, and wherein the brightness of a light source of the liquid crystal display is increased when the output face is in the second state.

In another embodiment of the invention there is a method of operating a mobile device between a first mobile mode and a second usage mode. The method comprises providing a fiber optic image guide having a plurality of optical fibers extending between an input end and an output end. Each of the plurality of optical fibers comprising a core material and a cladding material. At least a portion of the plurality of optical fibers has at least one of the core material and the cladding material being elastic at operating temperature. The input end of the fiber optic image guide is optically coupled to an external display surface of an information display of the mobile device. The output end of the fiber optic image guide is at least partially elastically deformed between a first state and a second state. A second output image formed at the output end in the second state is optically different than a first output image formed on the output end in the first state.

In one aspect of the embodiment the deforming includes applying a force to at least a portion of the output face when the fiber optic image guide is at an operating temperature greater than a glass transition temperature of at least one of the core material and the cladding material.

In another aspect of the embodiment the deforming is rotating the output end with respect to the input end.

In another aspect of the embodiment the deforming is stretching at least a portion of the output end.

In another aspect of the embodiment the information display is a liquid crystal display, and the method further comprises increasing the brightness of a light source of the liquid crystal display during or after deforming the output end to the second state.

In another aspect of the embodiment the information display is a liquid crystal display and the light source employs optical means to collimate light emitted.

It will be understood by those of ordinary skill in the art that the designs and methods of the present invention, particularly those pertaining to new module and case construction techniques utilizing either fused or flexible fiber optic image guides and tapers, apply to a wide variety of consumer products and are not limited to digital wrist watches. Examples include, but are not limited to, consumer products such as mobile phones, portable game units, notebook computers, portable DVD players, multi-lingual dictionaries, digital cameras or camcorders, digital watches, and MP3 or video players.

### BRIEF DESCRIPTION OF THE FIGURES

FIGS. 1a-1c illustrate the stages in the production of a prior art fiber optic image guide taper with a fixed magnification or demagnification capability.

FIGS. 2a-b illustrate the operational modes of one embodiment of a display system incorporating an elastic fiber optic image guide affixed to an underlying information display.

FIGS. 3-5 illustrate several possible interconnections between the mechanical stretching systems employed and the interface with the elastic fiber optic image guide.

FIGS. 6-7 illustrate the generally accepted mechanical deformations that occur when a free-standing elastic sheet is subjected to uniaxial or biaxial strain, respectively.

FIGS. 8a-b illustrate an embodiment of an elastic fiber optic image guide that is oversized to the active display area of the information display to which it is optically coupled.

FIGS. 9a-b illustrate an embodiment wherein the elastic fiber optic image guide is oversized with respect to the underlying active area of the information display so that when in a magnified or enlarged state the area of the magnified active area appears uniformly magnified.

FIG. 10 illustrates a flow chart of steps to optimize the quality of the enlarged or rotated image.

FIGS. 11-13 illustrate various mechanisms by which the overall product casing and/or user input areas of mobile products might accommodate an enlargement to support the desired display area enlargement produced by the stretching of an elastic fiber optic image guide optically coupled and/or affixed to an underlying information display.

FIGS. 14a-c illustrate one construction of a mobile product having a protective lens cover and product casing around the elastic fiber optic image guide and underlying information display.

FIGS. 15a-b illustrate motorized actuation of shape of mobile device between a small high mobility mode and larger usage mode.

FIG. 16 illustrate construction of a watch including an elastic fiber optic image guide.

FIG. 17 illustrates how a bezel in a mobile consumer electronic device can permit the image plane of fiber optic image guide to be varied in the z axis.

FIG. 18a-c illustrates how a fiber optic image guide could be integrated into a watch with a rotatable bezel and resulting digital time display.

### DETAILED DESCRIPTION OF THE PREFERRED EMBODIMENTS

The present-invention makes use of fiber optics for the ability to transmit light, particularly image information by using a coherent bundle of many optical fibers that have been fused together.

Many mobile devices today utilize information displays that often force a compromise in the overall device size or function of said device. Devices such as a MP3 player, video player, game device, mobile phone, digital camera, etc. are preferably designed to be extremely mobile. Most customers equate mobility with a small size. When a user attempts to interact with the device they need to interface with the information display, and therefore a larger size would almost always be preferable. No information displays on the market today offer variable size, and displays are typically constructed with rigid glass or plastic materials. Thus, designers and engineers most often compromise and utilize an information display of a size that lies somewhere between a small size desired for mobility, and larger size needed for functionality. Since the information display is of a fixed size they typically then use similar corresponding area for the input means, such as a keypad on a mobile phone.

In one embodiment of the present invention there is an information display or means integrated with an information display that would provide a workable smaller, higher mobility size that could then be expanded to a larger information display when in a usage mode.

For many mobile consumer electronic devices the function provided is tied directly to the information that is presented on the information display incorporated in the device. Mobile consumer electronic devices include, but are not limited to, mobile phones, MP3 players, mobile game devices, handhelds, DVD players, digital cameras or camcorders, digital watches, and notebook computers or Tablet PCs. In such devices the product preferably includes a smaller “mobile” size when in limited operation mode for higher mobility. The product would preferably expand to have a larger information display screen size, and possibly a larger user input area as well when in selected usage modes. Many mobile products on the market today instead settle on a less than perfect averaged solution. The information display is not so small as to provide the highest mobility, and not large enough to provide optimized readability during usage modes (and/or to be able to display all of the information that these devices are now capable of displaying).

It would be preferable to provide a product with smaller size for higher mobility, but then offer expandability for easier interface and larger information display screen size while in usage. One potential solution that some companies are working toward is a product called Readius announced by Philips. This product will purportedly make use of very flexible displays that effectively can be rolled up and then rolled out when in use. One of the problems with such a type of display (even if it should become commercially available) is that even the most flexible screens envisioned today still will not typically be able to be bent at extremely tight radius to allow curling up and still support high resolution TFT (thin film transistor) pixel controlling means such as are employed in LCDs today. Moreover, this proposed product fails to provide any mechanism to enlarge, magnify, rotate (twist), or physically change the size or shape of the information display.

It should be understood that the term information display as used herein is intended to encompass a wide variety of displays including, but not limited to, liquid crystal displays (twisted nematic, super twisted, active matrix, liquid crystal on silicon), organic light emitting diode (OLED) displays, and dynamic scattering liquid crystal displays. The term information display is also intended to encompass other displays in commercial use or under development that could be utilized in one or more embodiments of the present invention, such as liquid crystal on silicon (LCOS). Those skilled in the art will also recognize that most, if not all, of the embodiments disclosed herein involving the use of a fiber optic image guide could be utilized with any of the wide variety of information display technologies just discussed. It should be understood that for both liquid crystal displays and OLEDs, continued development is ongoing to produce displays with plastic or polymer outer substrates. This continued development might permit for either some curvature or flexibility of, for example, the external display surface of the information display. Such curvature or flexibility further enhances the design possibilities of these information displays as well as their durability. For applications wherein the underlying information display has a plastic or flexible surface, it is contemplated as within the scope of the invention that the bottom face of the fiber optic image guide could also be non-planar to better couple (optically and/or physically) to the external display surface of the information display.

For purposes of the present invention, it should also be understood that the term fiber optic image guide is interpreted in its broadest sense as any material that embodies the essential optical properties of a fiber optic image guide. Thus, the functioning of any particular embodiment of the present invention is not dependent upon the use of, for example, a fused or non-fused bundle or array of optical fibers. The functioning of any particular embodiment is instead dependent on, for example, the use of any material layer, (such as a fused bundle [i.e., the present invention includes, but is not limited to, a face plate] of optical fibers), that is capable of preferably all of the following: total internal reflection, controllable numerical aperture (NA) at input (preferably bottom) and output (preferably top) surfaces, and rotational azimuthal averaging. In particular, the fiber optic image guide shall be capable of translation of the object plane from the rear surface of the layer to the front surface of the layer. It should be apparent to those skilled in the art that these essential optical properties could be imparted to a range of materials, thus producing fiber optic image guides and optical equivalents such as waveguides.

Moreover, it should also be understood that a fiber optic image guide is generally made up of a number of individual fibers. Thus, on a macro scale, the fiber optic image guide has a bottom face and a top face. Each of the top and bottom faces is comprised of the individual fiber surfaces. These individual fibers are preferably fused together after the fibers have been drawn in the manufacturing process. Another production technique, however, will include fibers fused with heat and possibly pressure as is detailed in published US patent application 2005/0265765 to Welker et al. titled “Method For Producing Parallel Arrays Of Fibers” wherein the fibers are put directly onto a fusing “wheel” as the fibers are drawn on a tower. Alternative embodiments contemplated within the scope of the invention include, but are not limited to, fibers preferably fused all at once during extrusion, fusion of the fibers to one another with an adhesive or epoxy, and fibers simply packed tightly together to produce an effective coherent bundle.

Another production technique that could be employed to produce a fiber optic image guide involves the use of photolithography to cure core and cladding materials that would define the size, shape, and position of the individual fibers that would constitute the fiber optic bundle, or image guide. This technique is described in U.S. provisional application Ser. No. 60/847,165 filed on 26 Sep. 2006 and titled “Watch Image Guide And Method Of Manufacturing Elastic Fiber Optic Image Guides.” In that technique both a core and cladding material are UV curable and exposed using a UV photomask to first cross-link one material, and thereafter to cure the other material resulting in a fiber optic image guide with very accurate control of the size, shape, and placement of the individual fibers within the image guide. The fiber optic image guides of the present invention are not limited to those produced using the methods described herein. It is contemplated as within the scope of the invention that the fiber optic image guides of the present invention might also be produced using other methods.

With the above in mind, briefly note the following additional details with respect to the “macro” surface(s) of the fiber optic image guide. During heat or extrusion fusion of the fibers together, the fibers ideally fuse together with slight deformation that might affect the visual image slightly. Many commercial applications of fiber optic image guides (such as some medical applications) use small fibers (sub 25 micron diameter) so the packing efficiency (gaps between the fibers) is correspondingly small. It should be understood that smaller fibers are typically more expensive. Thus, commercial applications of embodiments of the present invention in various consumer products will preferably make use of fibers with larger diameters when possible. Embodiments of the present invention preferably include, but are not limited to, fibers having diameters in the range of 25-250 microns. Such diameters are believed to be optically acceptable for many consumer products including, but not limited to, watches, MP3 players, and mobile phones. However, it should also be understood that the present invention is not limited to fibers having a diameter of greater than 25 microns. This is particularly true since, as production techniques undergo further development and are refined, costs continue to go down. Thus, smaller diameter fibers, while not presently preferred, are nonetheless a more commercially viable proposition in the future. Moreover, smaller diameter fibers may be necessary in some high resolution displays such as active matrix liquid crystal displays used in mobile phones.

As just noted, cost can be a constraint in the commercial implementation of various embodiments of the present invention. For commercial embodiments in which a liquid crystal display is used and where price is a significant constraint, the cheapest form of liquid crystal display is preferably selected. Reflective or transflective twisted nematic and dynamic scattering liquid crystal displays are generally the cheapest type of liquid crystal display. Consequently, these two displays often find use in digital watches. The next level up in cost is the super twisted liquid crystal displays followed by active matrix liquid crystal displays or liquid crystal on silicon (LCOS). These types of LCDs are predominantly used in mobile phones, MP3 players, and many other consumer electronic devices. Super twisted liquid crystal displays might be used in watches as well, but the electronics to drive them usually consume a large amount of power (relatively speaking given the types and sizes of batteries used in watches). In the mobile phones category the current most popular LCD technology is color active matrix for most phones, and super twisted for the lower priced phones.

In describing the present invention reference will often be made to an external display surface of the information display. Use is made of this terminology instead of top or bottom surface of the information display to avoid confusion as the terms top and bottom surface may be used at times herein to describe the fiber optic image guide. The term “external display surface” was selected to further reduce confusion as to which surface in a display is that capable of providing information at a display surface. For example, in a twisted nematic liquid crystal display, the image is actually internally generated, typically on the back polarizer surface that does the last absorption of twisted light producing the dark segment. “External display surface” is used to indicate the last material surface of the information display the light is transmitted through on its way toward the fiber optic image guide. Thus, in a conventional twisted nematic display the external display surface would be the top polarizer, while in an organic light emitting diode display the external display surface would be the top glass or plastic substrate. It should also be understood that this term is thus intended to encompass both emissive and reflective (i.e. non-emissive) display technologies.

It should also be understood that, as used herein, the term optically coupled is a subspecies of the more general notion of coupling two optical elements together. To optically couple two optical elements together is intended to encompass those situations wherein a substantial portion of the light exiting the face of the first optical element impinges on a face of the second optical element. As a non-limiting example, the input (bottom) face of the fiber optic image guide and the external display surface of the information display are preferably optically coupled together. Thus, a substantial portion of the light exiting the external display surface of the information display will impinge upon the input face of the fiber optic image guide.

In some embodiments of the present invention the components that are optically coupled together will directly contact one another. It should be understood that direct contact is intended to encompass those situations wherein the components are retained in contact with one another by an intervening adhesive or epoxy. It should also be understood that it is contemplated as within the scope of the invention that two components that are optically coupled to one another might include an intervening gap between the exit face of the first component and the entrance face of the second component.

The optical fiber comprises a core and cladding, where the refractive index of the cladding is less than that of the core producing total internal reflection of light within the fiber. The core and cladding material are preferably transparent, but in some cases conventional dyes, fluorescent dyes, pigments, or other colorants or additives could be used in either the core or cladding to produce various optical effects on any image data transmitted in a fused image guide with optical fibers of this nature. In one embodiment a dark or black colorant could be added to the cladding layer to assist in improving contrast.

Fiber optic image guides (also known as fiber optic image conduits) and tapers are typically coherent bundles used to improve, enhance, magnify, minify, or record an image. They are similar to fiber optic faceplates in that the glass or plastic optical fibers are arranged coherently so as to transmit an image from the input plane to the output plane, but are typically thicker than just a couple of millimeters. It should be understood that the more general term fiber optic image guide encompasses the more specific term of fiber optic face plate. It should also be understood that fiber optic image guides may or may not be initially tapered, depending on the preferred configuration for a given commercial application.

Prior art fiber optic image guides utilize rigid core and cladding materials that typically are glass or polymers such as polystyrene, acrylic, and standard fluoropolymers. These types of core and cladding materials generally result in fused fiber optic image guides that are rigid. Fiber optic arrays or bundles of either plastic or glass are able to be transformed into fixed tapers or fixed twists. Tapers feature a fiber optic image guide wherein the surface area of the individual optical fibers on one face of the array are larger than the surface area of the fibers on the opposite face. The larger surface area features an enlarged viewable area, and a magnification of any image formed on the face of the image guide with smaller surface area. Twists are fiber optic image guides that rotate the image with respect to any image formed on the opposite side. In a twist, the position of the optical fibers on one side of the image guide are rotated at some angle with respect to the position of the corresponding optical fiber on the opposite side of the image guide.

Prior art tapers and twists are typically produced by taking fused image guide material and heating to temperatures above the glass transition temperature of the cladding and/or core material used within the fibers (typically to hundreds of degrees Celsius) to soften these materials. While at this elevated temperature the fiber optic image guide is subject to a mechanical force that either pulls two ends of the image guide to produce tapers between the two outer stretched ends, or twists one side of the image guide while keeping the other side of the image guide fixed. The fiber optic image guide so modified is then allowed to cool to room temperature leaving either a taper with a fixed and permanent magnification, or a twist with a permanent angular rotation of any underlying image.

Prior art fixed tapered fiber optic image guides include optical fibers that on one external surface have a smaller diameter than the diameter of the corresponding optical fiber on the opposite external surface. When viewing the top surface of a taper which has the larger optical fiber diameters, one will see a magnified image, and inverting the taper orientation will result in a minimization of the output image. Emagin is a company that specializes in organic light emitting displays (OLED) and on their Web site (www.emagin.com) they sell a fiber optic taper product that is designed to interface to the outside top surface of the information display and is used to present a magnified, flat image of the OLED visible to the user. This product uses a fixed fiber optic taper to allow customers to enlarge the apparent size of the OLED display used in their particular product application.

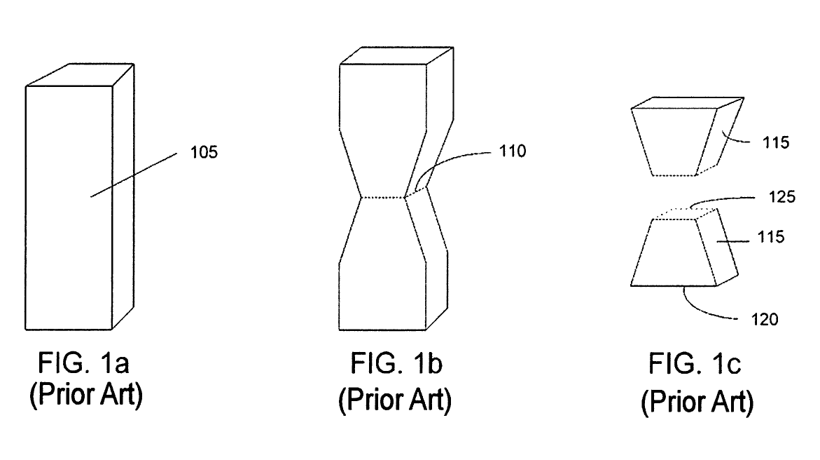

FIGS. 1a-1c helps illustrate how a prior art fixed fiber optic taper is typically manufactured. A conventional fiber optic taper production process involves a fiber optic image guide 105 of some thickness. A portion of the image guide 105 is heated above the glass transition temperature of the optical fiber materials at which point they become elastic and malleable. The outer edges of the image guide 105 are then pulled or they can even be heat pressed apart. The result as illustrated in FIG. 1b is that there is a necking or stretching down of the optical fibers in the middle area to a maximum necked down region 110 based on principles of mechanical deformation of elastic materials. The diameter of the optical fibers in the necked down region 110 are then of a smaller diameter than those of the optical fibers in the outer edges of the fiber optic image guide 105. Once the fiber optic image guide cools down it is subsequently cut in half in the necked down 110 region as illustrated in FIG. 1c. At room temperature the glass or plastic materials constituting the core and/or cladding materials are no longer above their glass transition temperature and therefore are no longer elastic. Instead what remains is a fiber optic taper with a fixed magnification. The fixed magnification is a function of the difference between the smaller and larger diameters of the optical fibers on the two ends.

The resulting two image guides 115 produced using this methodology each then have one external surface wherein the diameter of the optical fibers on that surface 120 is larger than the diameter of the optical fibers found on the other external surface 125 located in the necked down region 110. The difference between the surface areas of the optical fibers of the two different surfaces determines the fixed degree of magnification or demagnification the fiber optic taper is capable of producing. As illustrated in these figures the process of producing a fixed fiber optic taper is largely a function of the inherent mechanical and elastic properties of the materials (while heated to temperatures above their glass transition temperatures). In most cases the fiber optic tapers manufactured by this process use a fiber optic image guide constructed out of hard plastic such as polystyrene or acrylic as the core, or glass. Necking is a deformational phenomena more often noticed in “cold stretching” of more elastic polymers or rubbers. To get the hard plastic or glass core and cladding components of the fused optic fibers to produce the necking effect resulting in thinner diameters requires heating up these materials, typically above the glass transition temperatures of said materials used within the image guide. U.S. Pat. No. 5,303,373 to Harootian, Jr. titled “Anamorphic Fused Fiber Optic Bundle” discusses another way to produce a fixed fiber optic taper. Instead of stretching a fused fiber optic image guide block of material the image guide material is put it into a die. With pressure and heat the fiber optic image guide is effectively pressed down to form tapers of the desired magnification as defined by the structure and form of the die.

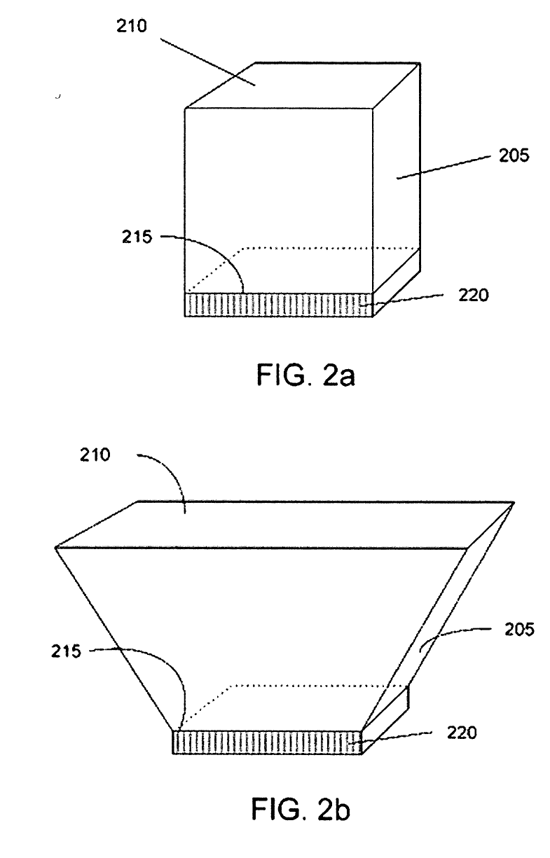

FIG. 2a illustrates an embodiment of a fiber optic image guide 205 that is constructed with elastic materials, such as polymers, thermoplastic elastomers, or rubber, in either or both its core and cladding of the individual optical fibers. Those of ordinary skill in the art should understand that there are numerous polymer, thermoplastic elastomers, fluoropolymers (it should be understood that while standard fluoropolymers are insufficiently elastic, increased elasticity might be available via the use of various plasticizers or softening additives) and transparent rubber materials that could be used. In a first state the fiber optic image guide 205 has an output face 210 wherein the diameters of the optical fibers at output face 210 are about the same size as the diameters of the optical fibers found at input face 215 of the fiber optic image guide 205. The fiber optic image guide 205 is optically coupled to an information display 220. In this first “non-stretched” state the fiber optic image guide 205 preferably only retransmits information from the underlying information display 220 optically coupled to the input face 215 of the fiber optic image guide 205. Thus, in the first state the fiber optic image guide preferably provides no magnification or demagnification effects, and is basically a 1:1 image transfer. The unique property of fiber optic image guides is that, to an observer, the image guide appears to “lift” the image information to the output face 210 of the fiber optic image guide.

FIG. 2b illustrates an idealized shape of a fiber optic image guide 205 that is subjected to a deforming force. Such force is most likely in the form of a stretching or pushing force on some portion of the fiber optic image guide 205. The fiber optic image guide 205 is constructed with some portion of the fused optical fibers constituting materials that are non-rigid in typical operating temperatures. The resulting fiber optic image guide 205 would then have a core and/or cladding that would elastically deform when force is applied. FIG. 2b illustrates an embodiment wherein mechanical force is applied to some portion of the image guide so that the output face 210 of the image guide deforms to an “enlarged”, or “stretched state”. In this new “stretched” or “enlarged” state, the end of at least some of the optical fibers on the output face 210 are now elongated and have larger surface areas (preferably larger diameters) than the end of the corresponding optical fibers on the input face 215. The result is a magnification of the graphical, textual or other information produced by the underlying information display 220 that is visible at the output face 210 of the fiber optic image guide 205.

The degree of magnification is a function of the differing areas of the optical fibers at the two surfaces. Magnification is preferably a function of the different diameters of the individual optical fibers at the output and input surface of the image guide when the optical fibers are round. It should be understood that physically altering the shape of the image guide could result from uniaxial stretching or biaxially stretching through either a pushing or pulling mechanism. The optical fibers in their stretched state might be more elliptical than round. A fiber optic image guide is preferably constructed with either or both the core and cladding materials being non-rigid, and preferably fully elastic. Thus, the fiber optic image guide could then have the area of at least a portion of its output face effectively expanded or stretched with either an uniaxial or a biaxial force, while keeping the input face 215 fixed. The stretching effectively turns at least a portion, if not the entirety, of the fiber optic image guide 205 into a fiber optic taper. The surface area of the optical fibers on the stretched output face 210 would have a larger surface area than those on the input (non-stretched) face 215. Thus, the stretching produces a corresponding degree of magnification or demagnification as a function of the difference between the diameters of the fibers on the input and output faces. When a deforming force is applied, the output face 215 of the image guide would appear to be an enlarged and magnified image of the underlying information display 220.

In one embodiment of this invention the underlying information display 220 is constructed out of hard materials such as glass or plastic, and therefore represents a rigid surface that will not expand or stretch. It should be understood that an elastic fiber optic image guide 205 could also be used with a rollable information display 220 constructed with plastics or polymer substrates. The fiber optic image guide 205 is stretched between output surface 210 and preferably non-stretched input surface 215. A fiber optic image guide 205 affixed to an information display 220 can then be utilized in a mobile device. The resulting mobile device could feature a first mode featuring a smaller display for high mobility, and expand to a second mode with an enlarged viewing area of the top surface 210 of the fiber optic image guide 205. In this enlarged viewing area mode the user would perceive an enlarged and magnified image of the underlying information display 220.

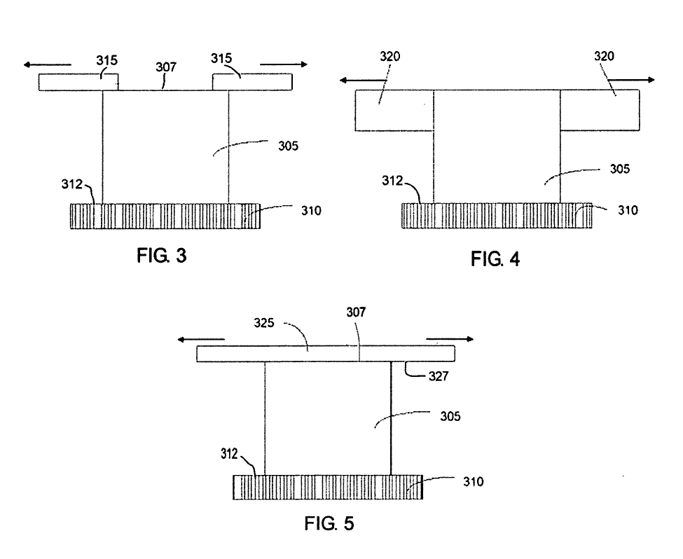

FIGS. 3-5 illustrate another embodiment of this invention and illustrate some possible implementations for the various connection means to apply a force that can deform a portion of the fiber optic image guide 305. The force is designed to physically deform some portion of the image guide resulting in an enlarged or magnification state.

FIG. 3 illustrates a two-dimensional representation of an elastic fiber optic image guide 305 in its non-enlarged state. Fiber optic image guide 305 is optically coupled to an underlying information display 310. Top connectors 315 are used, by a variety of methods known to those of skill in the art, to affix to a portion of the top surface 307 of the fiber optic image guide. The connectors 315 interface to mechanical means (not illustrated) to temporarily deform the output face 307 of the fiber optic image guide 305 into an enlarged magnification state. Those of ordinary skill should understand that numerous mechanical means could provide the necessary force to result in a deformation of the image guide. These mechanical means can include, but are not limited to manual force by the user, such as pulling or pushing on some portion of the product, or motorized through the use of actuators or motors.

FIG. 4 illustrates an elastic fiber optic image guide 305 attached to external display surface 312 of the information display 310. In FIG. 4 an interface between the mechanical force and the image guide is connected to at least a portion of the external perimeter of fiber optic image guide 305. When force is applied it deforms some portion of the image guide 305 to produce a second enlarged and magnified state. The mechanical force can be manual force by the user, or by motorized means including motors or actuators. As previously mentioned, the upper portion of the image guide 305 could be any area that is not affixed and prevented from any stretching or similar deformation.

FIG. 5 illustrates an embodiment wherein at least a portion of bottom surface 327 of overlay sheet 325 is affixed to the entire output face 307 of the fiber optic image guide 305, not just the edge or the corner. The mechanical properties of the material used are matched to the desired elongation and resulting stretching effect to be produced in the output face 307 of fiber optic image guide 305. The overlay sheet 325 is preferably transparent, and even more preferably very transparent, and has some elasticity characteristics. Examples include, but are not limited to materials such as elastomers, plastics and even natural or synthetic rubbers. The overlay sheet 325 is also connected to the mechanical system (not illustrated) that will stretch it. This results in a stretching of the underlying fiber optic image guide 305 to a desired enlarged magnification state. Those of ordinary skill in the art understand that mechanical forces to effect such image enlargement can be performed mechanically through actual manual stretching by the user or motorized stretching activated manually or automatically by a microprocessor in response to an event.

FIGS. 3-5 illustrate a two dimensional mechanical system, and therefore only illustrate a potential uniaxial enlargement. It should be understood, however, that it is contemplated as within the scope of this invention that the deforming forces could be uniaxial, bi-axial, or multiaxial as well. It should also be understood that any and all means that can be used to produce an enlargement, stretching, or increase in optical fiber diameters or areas on the output face are contemplated as within the scope of the invention.

There will be varying deformation across the output surface of an elastic image guide 305 of some thickness when it is affixed to a rigid surface, and subjected to uniaxial, biaxial, or multi-axial force. The degree of variation in the percent of deformation, or enlargement, across the output face 307 of the image guide 305 is a function of a number of properties, including, but not limited to: the modulus of elasticity, dimensions and shape, type and amount of mechanical force introduced, whether said mechanical force is uniaxial, biaxial, or multi-axial, rigidity of the underlying information display 310, and thickness of the fiber optic image guide 305.

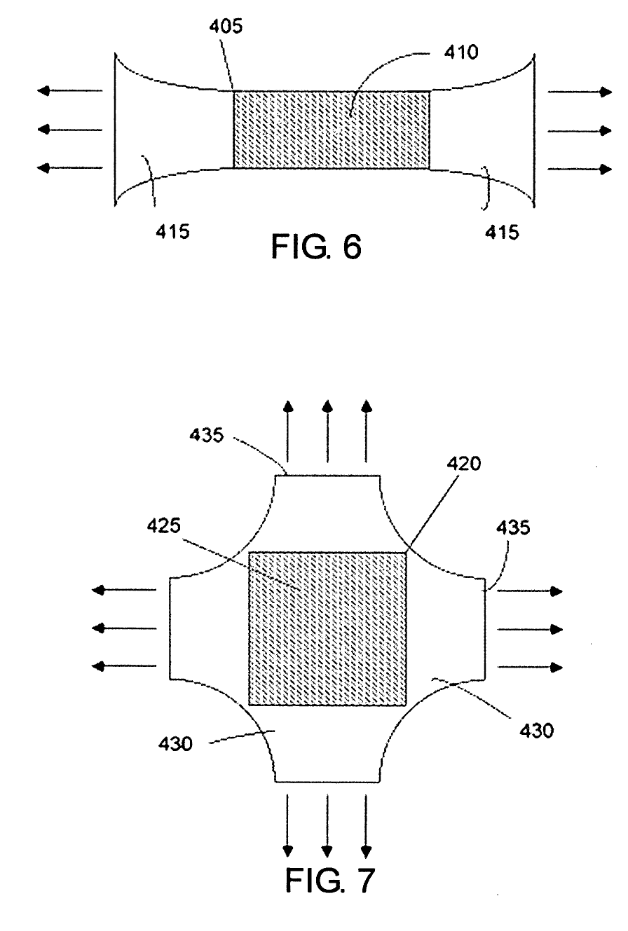

FIGS. 6-7 illustrate the deformation effect that typically occurs when a thin sheet of elastic material is subjected to a uniaxial or biaxial stretching. The amount of strain introduced determines if, and, if so, how much, necking and the uniformity of the elongation that may occur in the central region of an elastic thin sheet. Necking occurs when a material is stretched and the width of the material decreases or “necks” as a result of the fact that the material is stretched thinner in that area. The maximum necking occurs between the two stretched ends of a uniaxially stretched material.

FIG. 6 illustrates uniaxially stretching a thin sheet or film of elastic material 405 such as elastomers, or rubber, and the resulting necked down region 410 wherein there is some uniformity in the elongation in this region. As illustrated, the edges 415 of the sheet often produce a higher variance in the degree of elongation depending on location on the sheet and proximity to the edges where the force is being applied to stretch material apart. If using an elastic fiber optic image guide that is stretched, it is preferred to minimize the necking and effectively hold the width the same as at the edges. The system is preferably optimized in both the non-stretched and stretched modes so that the system is stretched to a desired percent elongation wherein necking does not result in any negative image effects.

FIG. 7 illustrates the typical appearance of a thin sheet 420 of thermoplastic elastomer or rubber that is subjected to a biaxial stretching force. There is a center region 425 where the elongation is fairly uniform, while on the outer edges 430 there are variations in the elongation of material. The basic mechanical principles are illustrated here of how elastic materials respond when under uniaxial or biaxial strain. This is a major consideration in the execution of designing a mobile device utilizing a fiber optic image guide affixed to an underlying information display to get 1:1 to some higher level of magnification effects of the display image after stretching has occurred. Where the input face of the fiber optic image guide is preferably attached to a rigid display substrate there are other issues that arise that further complicate the response of the material. Such issues are related to degree of strain, elastic and mechanical properties of the material, and thickness of the material to name a few.

In many applications there will be varying degrees of uniformity of elongation or magnification that may be acceptable. In some applications it may be desirable to have greater uniformity of the magnification of the fiber optic image guide in its stretched state. FIGS. 6-7 illustrate generally accepted material deformation of thin elastic sheets 405 and 430 when subjected to external uniaxial or biaxial stretching force and are free-standing with neither side rigidly affixed to a surface. Using these simple models as a basis for expected deformation of an elastic material under strain, it should be understood that one preferred embodiment to achieve a more uniform magnification of the display surface in the enlarged magnified or “stretched” state would be to center the display region 410 or 425 that is observable to the user of the product by masking the remaining regions with a bezel or case of the mobile electronic device.

FIG. 7 illustrates that the edges 435 of the elastic sheet (assumed to be where the biaxial strain is introduced) remain fixed at the same length as the original unstretched sheet of material 405. Another preferred embodiment of this invention is a biaxial stretch of the elastic fiber optic image guide wherein one or more of the edges 435 of the sheet actually expand to match the expansion along the other axis. For example, expansion of all four edges of the sheet to match the expansion of the material along the opposite axis results in an enlarged square sheet versus the even-sided cross-like shape illustrated in FIG. 7. Also attachment mechanisms may be employed when an expandable edge system is utilized wherein the entire sheet is not uniformly attached, but hinged in several places to better permit the effective elongation of the edges. Those of ordinary skill in the art will understand that if an elastic fiber optic image guide was affixed to a rigid surface and the top portion was subjected to a uniaxial, bi-axial, or multi-axial force, the center area 410 and 425 of the fiber optic image guide would likely deform non-uniformly as a function of thickness and shape.

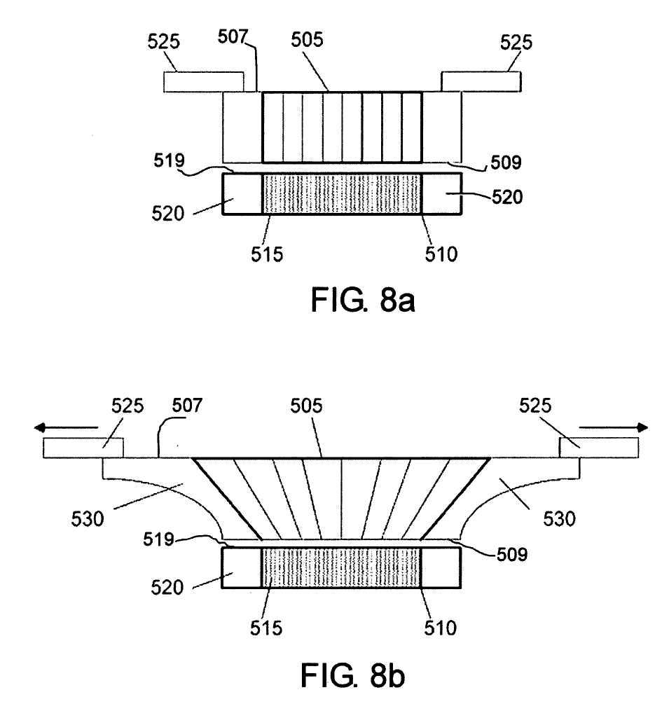

FIGS. 8a-8b illustrates another embodiment of this invention for improving the display appearance in the enlarged mode. One solution is to oversize the elastic fiber optic image guide 505 in relation to the active display area of the underlying information display 510. FIG. 8a illustrates the non-enlarged mode of fiber optic image guide 505 affixed to an underlying information display 510. The information display 510 has an active region 515 and an inactive display region (no pixels) 520 around the active display region. A gap is illustrated between the bottom external face 509 of the elastic fiber optic image guide 505 and external display surface 519 of the information display 510. However, the input face 509 of the fiber optic image guide 505 is preferably optically coupled and/or directly affixed to the external display surface 519 of the information guide 510. The fiber optic image guide 505 is preferably affixed in one of a variety of ways so that the bottom surface does not change in size or dimension when a deforming force is applied to some upper portion of it. Additional connections 525 are connected to the output face 507 of the elastic fiber optic image guide 505 to allow a mechanical force to introduce a uniaxial stretch of some upper portion of the fiber optic image guide 505. In FIG. 8a the display image is transmitted from the output face 507 of the fiber optic image guide 505 at 1:1 with no magnification or enlargement of the image from information display 510. The dimensions of the fiber optic image guide 505 are oversized with respect to the underlying display 510 in the “non-stretched state”. In an actual product application a product cover or bezel would preferably be employed over this area of the elastic fiber optic image guide 505 so it is not visible to a user.

FIG. 8b shows the elastic fiber optic image guide 505 after a uniaxial mechanical force has temporarily modified its physical dimensions. The area of the elastic fiber optic image guide 505 that is centered over the active display area 515 of the information display 510 expands more uniformly in the area that is transmitting the active display information than on the edges. The edge area 530 of the fiber optic image guide that is not transmitting any of the active display information 515 experiences less uniform elongation, and resulting magnification. It should further be understood that the portion of the fiber optic image guide 505 that would experience these non-uniform edge effects 530 is preferably oversized, and not attached to any lower rigid surface. All of these and related variations are contemplated as within the scope of the invention in an effort to produce a more uniform magnification effect across the active display surface.

It is recognized that since the input surface of the fiber optic image guide 505 is often attached to a rigid surface, force applied to enlarge the upper portion of the image guide will often result in non-uniform enlargement of the surface area of the individual optical fibers. The non-uniform enlargement is a function of the thickness of the image guide, dimensions of the image guide, mechanical force applied, and mechanical characteristics of the image guide materials used. A variety of methods may be utilized to produce a more uniform enlargement of the surface areas of the individual optical fibers across the entire fiber optic image guide.

One embodiment used to accomplish this desired effect of more uniform magnification across the top surface of the fiber optic image guide 505 is varying the materials used to construct the optical fibers. For example, the optical fibers found closer to the center of the image guide 505 could have a higher elasticity versus the fibers on the outer edges of the fiber optic image guide 530. The effect of such a construction is that when uniaxial, biaxial, or multi-axial force is applied, lower strain is experienced near the center of the image guide 505. This is due to retention of expandability by the non-expandable external display surface 519 of the information display 510. The output face 507 still experiences an equal amount of diameter or area expansion since its degree of elasticity is matched to the expected strain in its particular location. The higher strain found on the outer edges (nearer to the connections 525) of the fiber optic image guide 505 experience a higher elongation and non-uniform strain, but actually expands less since the optical fiber in those regions are constructed with materials of lower elasticity. One preferred objective of this embodiment is to utilize individual optical fibers of varying mechanical and elastic properties. Thus, when subjected to a specific strain, the resulting magnification of the active display information 515 will appear more uniform across the area of output face 507 the fiber optic image guide 505 visible to a user. The cost of constructing a fiber optic image guide with fibers of varying mechanical characteristics does increase the expected cost as well as increasing the complexity of the system. Examples of production methods currently under consideration are disclosed in the present inventor's copending U.S. provisional application Ser. No. 60/847,165 filed on 26 Sep. 2006 and titled “Watch Image Guide And Method Of Manufacturing Elastic Fiber Optic Image Guides.” Such disclosed production methods permit a more convenient way to produce a fiber optic image guide 505 wherein various portions could have either the core and/or cladding of the individual optical fibers made of UV curable material that may have varying mechanical characteristics.

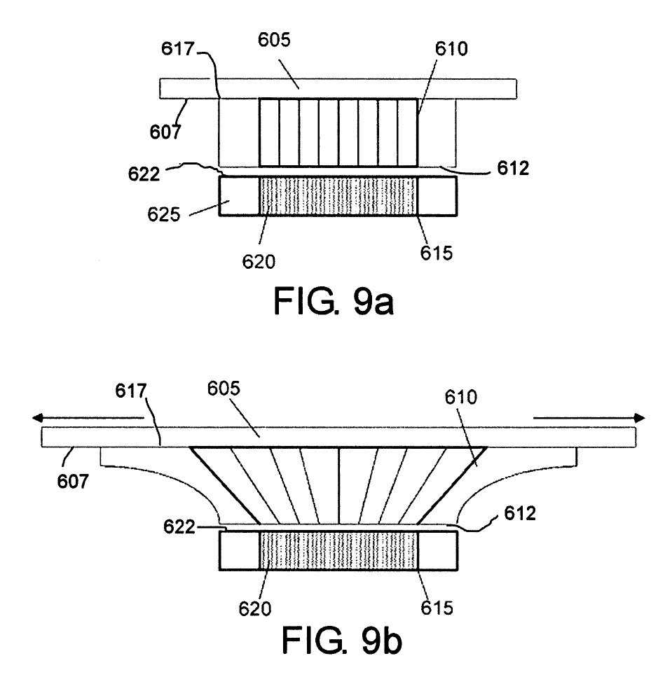

FIGS. 9a-9b illustrate another embodiment of this invention that utilizes an alternative approach to obtaining a more uniform magnification or elongation across the face of the elastic fiber optic image guide when subjected to a mechanical force. In FIG. 9a at least a portion of bottom surface 607 of an elastic transparent sheet 605 has been affixed to the output face 617 of the elastic fiber optic image guide 610. Input face 612 is preferably affixed and/or optically coupled to the external display surface 622 of information display 615. The stretching strain then introduced would be directly on the elastic sheet 605. That strain would secondarily effect the underlying elastic fiber optic image guide 610. In this particular example the gradient of mechanical properties would be introduced into this overlay sheet 605. Overlay sheet 605 preferably has uniform optical characteristics, namely in optical clarity and index of refraction. Overlay sheet 605 is also preferably produced with a mechanical variation providing some areas of the overlay sheet 605 that have higher modulus elasticity and other areas with lower modulus of elasticity. The transparent overlay sheet could be manufactured by extrusion, casting, or a variety of other ways to produce a sheet that has varying mechanical-elastic properties. Such properties are varied as necessary to provide a more optimized and equivalent elongation and magnification by the underlying elastic fiber optic image guide.

When the strain is introduced, as illustrated in FIG. 9b, the areas of the upper overlay sheet would be optimized so they cause an equivalent diameter or area increase of the optical fibers across the fiber optic image guide. The result would be a more uniform image magnification of the active area 620 of information display 615, while still allowing the use of an elastic fiber optic image guide that is constructed uniformly throughout. In some instances this may insure the lowest cost product solution versus varying the mechanical properties of individual optical fibers based on their location within the image guide itself as described in a previous embodiment.

Another potential negative image effect might occur in multi-colored displays such as thin film transistor LCDs, or other technologies is a specular colored effect that can be produced two different ways. One is a mismatch between the diameter sizes of the optical fiber and that of the underlying pixels. Those of ordinary skill in the art understand that the typical color active matrix thin film transistor display uses a combination of active elements each integrated with a particular color filter such as red, green or blue. The effective overall color of a pixel is a combination of the individual active elements turned on and their respective color filter. In additive filtering technologies, for example, a red, green, and blue color filter all turned on will produce white, and all turned off will produce black. The specular negative image effect might also occur as a result of core twist in the production of fiber optic image guides. Core twist occurs during the production of the image guide when the diameters of the optical fibers on one side are not coherently aligned with the identical fibers on the opposite side of the image guide. If viewing a line on a piece of paper a significant core twist would optically make the line appear jagged.

A fiber optic image guide with a significant core twist might be used in combination with a color display that uses separate color filters to create a single apparent pixel. The optical result of the core twist is that some of the active elements integrated with different color filters to make up one pixel may be transmitted on the output face and be visible at a position significantly far from its neighboring color filters. Consequently, the human eye is unable to assimilate the three color filters into the desired apparent color. If the display image is white, what in fact appears is a specular color variation across the fiber optic image guide of the transmitted display image. The individual color filter pixels are perceived and assimilated by the human eye so as not to produce a white color effect. The core twist is preferably minimized significantly so that this negative image effect does not occur. It is also preferable to reduce the size of the pixel elements and optimize pixel element size with respect to the diameter of each optical fiber. Thus, a smaller percentage of elements are not translated in transmission away from neighboring filters that collectively produce a single apparent pixel element.

Other mechanisms to remedy the negative optical effect might include using software or calibration. Thus, after the fiber optic image guide is coupled to the information display, the degree of core twist or non-correlation of the optical fibers is calibrated. The pixels and their color/shading are preferably calibrated to allow for the core twist optical displacement. Consequently, the software could modify the pixel information by each of the color filters from what it is supposed to produce at the display level to account for the variation produced by the fiber optic image guide. Thus, the new modified display image, once seen through the fiber optic image guide, will appear as desired.

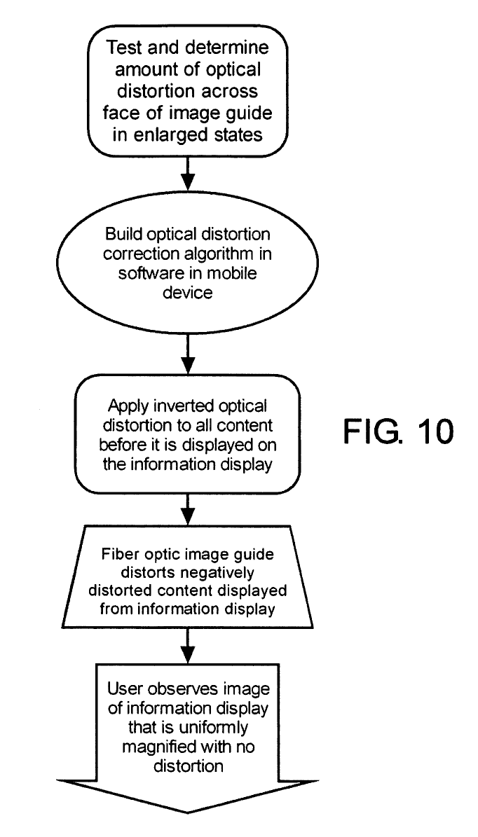

FIG. 10 illustrates a method of using software to modify the content formed on the information display to compensate for distortions and non-uniformity across the enlarged image guide. The varying distortions and magnification produced by the image guide are first measured or calculated. The variations could then be formulated into a correction algorithm, and the algorithm could be used to modify the image content before it is displayed on the information display. The inverted modified image content is then distorted by the fiber optic image guide as predicted. The final result preferably being that, when the fiber optic image guide is in its enlarged or magnified state, the image content displayed would appear to have uniform magnification.

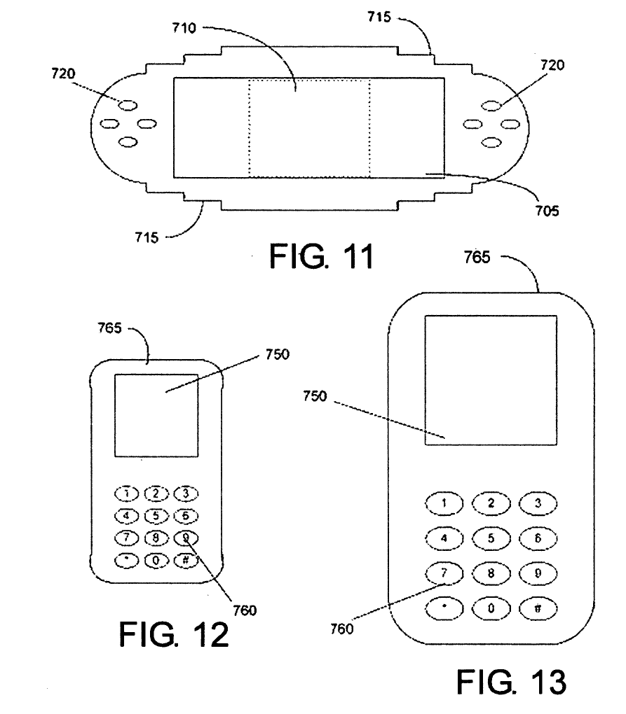

FIGS. 11-13 illustrate two possible ways that the overall dimensions of a mobile product could be expanded to allow for the expansion of the display screen and potentially the input means if desired. It should be understood that there are a wide assortment of other configurations and means that could be utilized that are contemplated as within the scope of this invention. FIG. 11 illustrates a consumer product, for example a mobile game device such as a Nintendo GameBoy or SONY PSP product. The device is illustrated in its stretched state or usage mode. The stretched display 705 utilizes an elastic fiber optic image guide attached to an information display that has been enlarged uniaxially from its original display dimensions 710 in the non-stretched or high mobility mode. The mechanical force introduced to uniaxially increase the size of the product in this example is done manually by a user. The user pulls on the two ends of the product to actuate it to a better usage model with a stretched and enlarged display area 705. Mechanically the user uniaxial strain is directly applied to the product casing, and potential components within would telescope out as indicated by 715, thereby varying the overall width of the product. These telescopic elements 715 of the product case design would preferably not be visible when the user effects a change of the device to its high mobility, or non-stretched display state 710. It is also assumed that the connections are utilized internal to the product (not illustrated) that attach to the elastic fiber optic image guide to effect the stretch and apparent enlargement and subsequent magnification of the underlying information display. Also, if a transparent cover is used over the elastic fiber optic image guide it is assumed it would also expand accordingly. The elastic fiber optic image guide now preferably might lay behind a bezel or product casing in such a way that in the stretched state what is observable to the user is display information that appears uniform across the display area. As noted in FIG. 11, some elements such as the input buttons 720 could retain their same size and dimensions in both states, or mechanisms could be employed to also effect a change in the size of the input means, or buttons.

FIGS. 12-13 illustrate another mechanism whereby a product, such as a mobile phone, could be expanded from a high mobility mode to a usage mode. In the high mobility mode the elastic fiber optic image guide preferably transmits the underlying information display at 1:1. In the usage mode the product is transformed to an overall enlarged product size, which includes an enlarged display area 750 and larger user input area 760, or numerical keypad in this illustration. FIG. 12 illustrates the mobile phone 765 product in its smaller, high mobility state, with a smaller display area 750, and smaller keypad or user input 760. The overall dimensions of the mobile phone 765 are enlarged either using electrically powered motors and gears, or actuators, or by user manual force (pulling apart, pushing together, rotating screen element, etc . . . ) In this enlarged state the display area is increased by the utilization of an elastic fiber optic image guide stretched biaxially as illustrated in this example. This example also illustrates a case when the input keypad or user input area 760 is enlarged as well.

In this particular embodiment some or all portions of the product casing may be made out of some non-rigid material, which could be polymers, plastics such as thermoplastics, elastomer, rubber, or even expandable metals that are commercially available. The keypad area 760, for example, could be a rubber overlay sheet with connections to the underlying printed circuit board. Those of ordinary skill will understand how this keypad could be enlarged. The actual overall enlargement of the product can be affected by a variety of means. One such means could involve one or more internally located small motors or actuators that push out platens on the various axes of the product casing. Portions of the product casing laid over these platens would then expand and stretch as the motors push these platens outward changing the overall dimensions of the product. There are numerous other methodologies that could be used to effect an overall enlargement of a mobile product and desired portions of the outside product inputs, connection means, display area, etc.

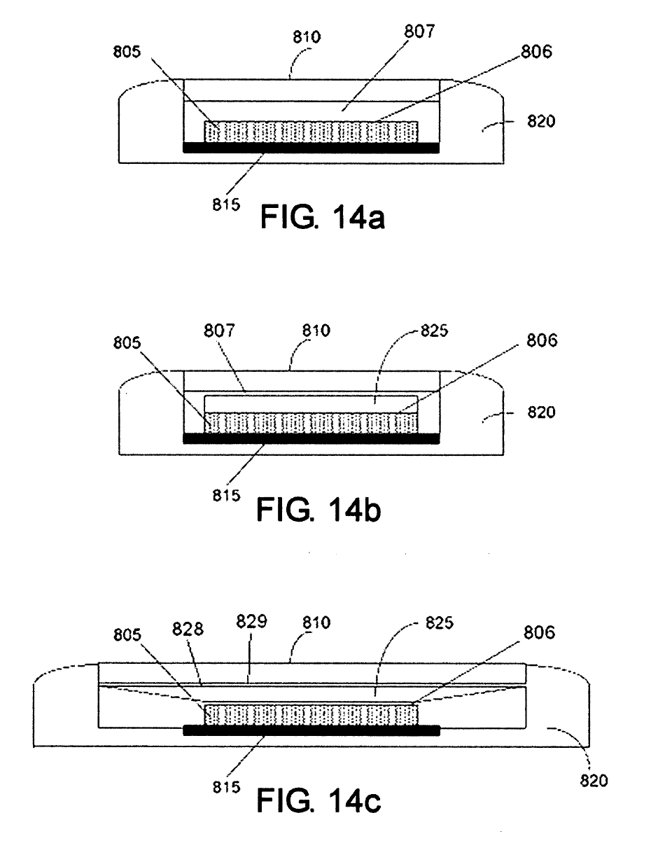

FIGS. 14a-14c illustrate cross-sectional views of a mobile device with an information display. An information display 805 of some kind, either reflective, transflective, or emissive, is preferably protected behind a clear plastic or glass cover 810. Cover 810 is typically constructed with an acrylic material with high optical clarity and good mechanical properties in regards to scratches as might result from normal wear and tear, dropping the device, etc. There is often a spacing layer 807 between the top lens cover 810 and the external display surface 806 of information display 805. This is to insure that should outside pressure be placed upon the product itself it will not damage or negatively effect the image quality of the information display. The lens cover 810 is preferably integrated with the product casing 820. The display 805 is attached by bracket or mount 815, either mounted on a printed circuit board or other mounting supports, to integrate within the product casing 820. FIG. 14b illustrates that in the typical mobile product application the elastic image guide 825 will preferably be optically coupled to the external display surface of the information display 805, preferably beneath the upper lens cover 810.

As illustrated in FIG. 14c, in this type of product configuration the external lens cover 810 would preferably be subjected to the same uniaxial, biaxial, or multiaxial force. The visible area under the lens cover 810 expands to reveal the expanding fiber optic image guide 825 output face 828 that displays a magnified information display 815. In those applications the same mechanical means, either manually activated or motorized, are responsible for stretching the fiber optic image guide 825. There is preferably a gap between the output face 828 of the fiber optic image guide 825 and the input surface 829 of the lens cover 810. The materials used in the lens cover 810 may be a polymer, rubber, thermoplastic, silicone, adhesive, or elastomer, with the characteristic that it also be highly transparent.

A wide variety of mechanical means, either motorized, or manually actuated are contemplated as within the scope of the invention to produce the necessary motive force to enlarge the output face. Thus, the resulting magnification effect might result from an introduced uniaxial, biaxial, or multiaxial strain. For example, in the mobile phone market there are currently a variety of ways that the device is “pulled” apart by the user, or rotated to reveal more of the display, or change the input area accessibility. Input means, such as a keyboard or keypad, buttons, or any user interface integrated into the product could expand accordingly, or change configuration as the user activates, actuates, or physically causes an enlargement of the outer display surface. This may be assisted by using some components of a mobile product internally that remain fixed, such as the printed circuit board (PCB), battery, and certain standardized input connections. In a mobile phone, for example, the input keys could be constructed out of a rubber or elastomeric material. The same or similar actuation means used to expand the elastic fiber optic image guide 825 could also actuate a change of the upper lens cover (if a lens cover is used) and other components or structure of the mobile product. On the mobile phone a construction as simple as a rubberized sheet with the keys and actuation means provided on the cover of the sheet could expand to some degree with the enlargement of the fiber optic image guide.

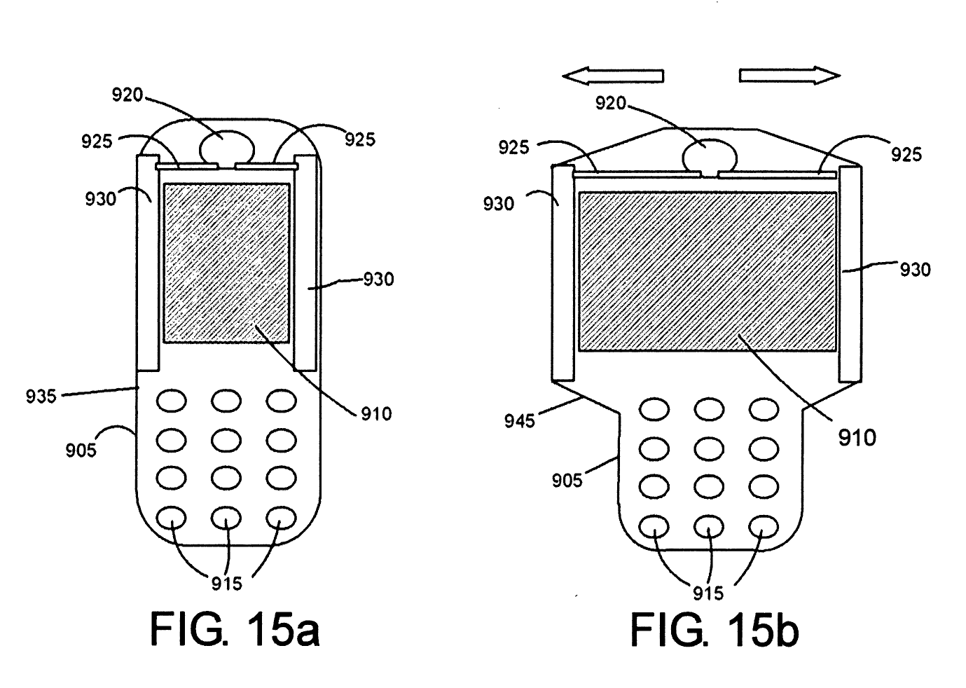

There are constructions of mobile devices that allow the user to manually rotate, open, or slide elements of the construction. However, there are no methods that detail the use of one or more small motors or linear actuators that can automatically actuate a change in the overall size, or shape of the mobile device. Heretofore there has been no need to alter the physical dimensions of any mobile device since the information display has been rigid with fixed dimensions. Based on the embodiments of the present invention relating to a new expandable means to an information display, as well as the eventual development of information displays with some flexibility, needs have changed. Now there is a need for a mobile device utilizing an expandable display of the present invention preferably in conjunction with motorized or user linear actuators that are powered and activated to initiate a change in the overall structure or size of the mobile device. FIGS. 15a-15b illustrate an embodiment of such an implementation.

FIG. 15a illustrates a mobile phone 905 with the top cover removed showing some of the internal components when the device is in high mobility mode. The information display 910 could be constructed with rigid materials affixed with a fiber optic image guide capable of expansion and magnification as taught herein or any type of flexible display technologies. Alternatively, if a flexible information display 910 is used it would preferably have some area of the information display 910 hidden or curved under it within the cross section of the mobile phone 905 (not illustrated). The mobile phone 905 would also preferably include various input means 915, in this case standard numerical buttons. A small motor 920 is connected, as by various means 925, which could be gears, shafts, or actuator arms, to two outer plates 930 that would constitute the outer structure and defining outer dimensions of the mobile phone. It is contemplated as within the scope of this invention that the motor 920 depicted could be any type of motor, or actuator, or specifically a linear actuator or any other similar electrical means that can generate an external mechanical force. It is also contemplated as within the scope of this invention that the motor or actuator means 920 could be in any location within the structure of the mobile phone and not necessarily restricted to the position illustrated in this figure.

Also illustrated in FIG. 15a are means 920 to actuate a movement of the plates 930 in an uniaxial direction. However, it is contemplated as within the scope of the invention that at least one motor or actuator 920 could be used to actuate a uniaxial, biaxial, or even multi-axial mechanical pushing or pulling force. Achieving bi-axial or multi-axial movement could also employ more than one motor or actuator 920 as well. A casing material 935 encases the mobile phone. The casing preferably has some portion of it with an elastic nature such as rubber, polymer, thermoplastic elastomer, or other similar material that can achieve expansion. Alternatively, the casing might be a hard material, and as the structure is expanded it would have an accordion-like or telescoping structure that would enable expansion of rigid materials. This embodiment details an electrically driven mechanized, motorized, or actuated mechanical force to physically alter the shape of the mobile device 905.

FIG. 15b depicts the same mobile phone 905 device except that the electrically driven motor 920 or actuator has driven the plates 930 away from each other. Thus, the outer structure of the mobile phone 905 has changed from a high mobility mode into an enlarged usage mode. In the usage mode the information display 910 with an elastic fiber optic image guide optically coupled and/or affixed to its external display surface would be in an enlarged magnification mode displaying the image from the underlying information display 910. The mobile phone 905 device illustrated in FIG. 15b could also represent an embodiment wherein the information display 910 is one of the various types of flexible displays, and in this enlarged mode portions that were previously hidden in the mobile phone 905 assembly are now visible. When the electrically driven mechanical force, be it a motor 920 or actuator, displaces components away from one another the information display 910 would preferably be connected by various means so that it expands as well. The outer casing 945 also expands to the new outer dimensions for the mobile device. In this depiction there is no enlargement of the input area 915. However, it is contemplated as within the scope of the invention to use electrically driven means to actuate an expansion of the input area. Although a mobile phone 905 is illustrated in these figures this embodiment of this invention is not limited to that mobile device application, and further includes mobile device such as mobile phones, digital cameras or camcorders, MP3 or video players, mobile game devices, DVD players, multi-lingual dictionaries, or laptops, tablet PCs, or handheld computers.

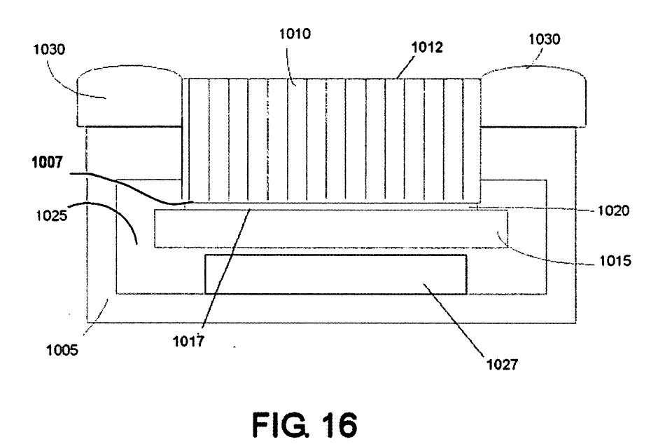

FIGS. 16-18 illustrate other embodiments of this invention wherein a fiber optic image guide of elastic nature is utilized in a mobile device, and in some applications is utilized so as to produce a rotational twist of an image.

FIG. 16 illustrates an embodiment of a digital watch 1005 having an elastic fiber optic image guide 1010. Fiber optic image guide 1010 includes input face 1007 optically coupled 1020 to external display surface 1017 of information display 1015. A module 1025 typically holds the information display 1015 as well as controlling electronics and power source 1027, typically a battery. The output face 1012 of the fiber optic image guide 1010 is preferably connected to a rotatable bezel 1030. In this embodiment no additional top cover is depicted. However, in some instances, due to the softness and tackiness that may exist with some fiber optic image guides 1015, an additional top lens cover could be utilized on top of the output face 1012 of the fiber optic image guide 1015.

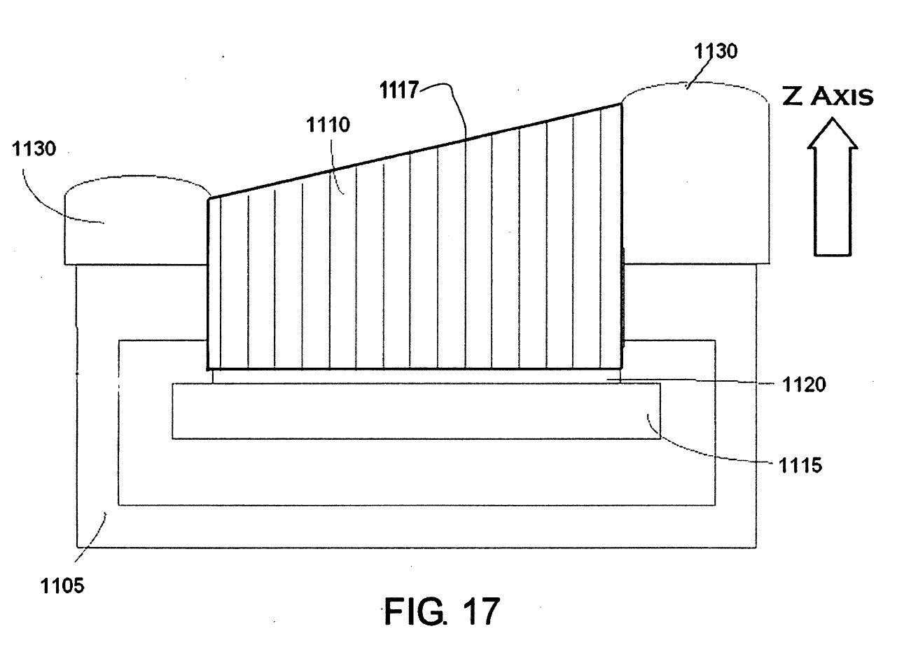

FIG. 17 illustrates an embodiment similar to that illustrated in FIG. 16. In FIG. 17 the watch case 1105 and outer bezel 1130 permit movement upward and downward in the Z axis versus the horizontal plane of the watch. In this embodiment the fiber optic image guide 1110 is optically coupled 1120 to the information display 1115. The fiber optic image guide 1110 stretches upward or downward in the Z axis whenever the surrounding bezel 1130 is actuated in the desired direction by the user. The advantage of this capability is that the user is able to vary the viewable plane of the output face 1117 of the fiber optic image guide 1110. This allows the user to put the angle of the output face 1117 at an angle facing the user instead of merely a horizontal planar orientation on the user's wrist as occurs in conventional watches.

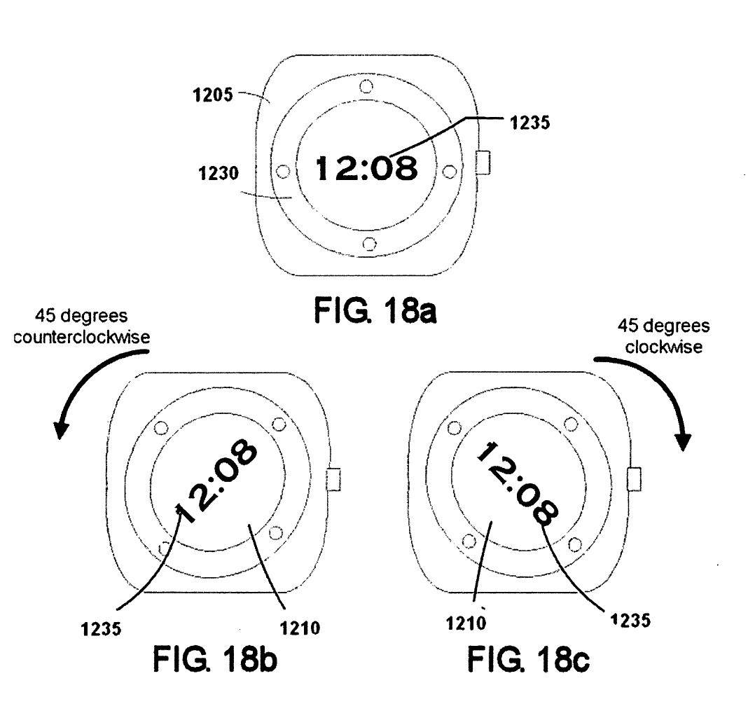

FIGS. 18a-18c illustrate another embodiment where a representation of the digital time 1235 is depicted which is produced on the outer face of the fiber optic image guide 1210 and produced by the underlying information display. FIG. 18a represents the unrotated position of the rotatable bezel 1230, which can then be rotated in the XY plane and the top portion of the fiber optic image guide 1210 attached to it rotates as well. FIG. 18b illustrates the digital time 1235 information when the bezel 1230 and fiber optic image guide 1210 has been rotated 45 degrees in the counterclockwise direction. FIG. 18c illustrates differing digital time 1235 information when the bezel 1230 and fiber optic image guide 1210 is rotated 45 degrees in the clockwise direction. The degree of twist that is possible is a function of the mechanical characteristics of the fiber optic image guide 1010 and thickness. It should be understood that although a digital watch 1205 is illustrated, this embodiment could be enabled for other mobile devices allowing one to non-permanently twist the information display image. While not illustrated in FIG. 18, it should be understood that it is contemplated as within the scope of the invention that the angles of rotation might be other than forty-five degrees (for example, five, ten, fifteen, twenty, twenty-five, thirty, thirty-five, forty, forty-five, fifty, fifty-five or sixty degrees). It should also be understood that it is contemplated as within the scope of the invention that the mobile device may be rotated to a plurality of different angles in either direction, and is not limited to simply one angle in either direction.

There are several embodiments detailed herein that describe various connections to the output face of the fiber optic image guide as well as the input face of the fiber optic image guide to the external display surface of the information display. Those of ordinary skill in the art recognize that such bonding may include, but is not limited to, an epoxy, adhesive, ultrasonic welding, mechanical pressure or clamping, or any other means to secure any surface or material that needs to affix to any external surface of the fiber optic image guide for any purpose.

Various embodiments of the present invention permit a device, but most preferably a mobile information device (including, but is not limited to, a mobile phone, MP3 or video player, DVD player, mobile game player, digital camera or camcorder, digital watch, laptop, handheld, tablet PC or notebook computer) to have a much smaller overall product dimensions in its mobile or non-use mode and then expand in a second usage mode. For example, the use of an elastic fiber optic image guide capable of producing 1:1 representation of the information display in a first mode, or produce varying magnification or other optical effects in a second mode. One optical effect might include a rotation or twist of the image with respect to the image produced by the underlying information display in the second mode. Another optical effect might include presenting that information as if it is emanating out of the output face of the image guide, versus merely refocusing the image plane as a typical lens. Using the embodiments herein mobile products can have one high mobility design and effective display size, and then automatically or at a user's discretion the display area and potentially all or part of the mobile product itself could be mechanically altered into an enlarged state for easier usage in a larger, magnified screen size, and potentially also a larger user input area.

As already discussed, a wide variety of configurations and/or shapes of the output face of the fiber optic image guide are contemplated as within the scope of the invention. The output face might define a single plane, and may be curved, define more than one plane, define a logo, etc. The top surface of the fiber optic image guide could be coated. The fiber optic image guide may comprise a plurality of fibers that are fused together or fibers simply packed tightly together to provide an effectively fused surface. Alternatively, the fiber optic image guide may include a plurality of fibers that are fused together at the ends, but include an intermediate flexible region wherein the optical fibers are not fused together. The fibers of the fiber optic image guide could be effectively fused together using either heat and pressure, an adhesive between the fibers, tight packing of the fibers within some construction, or extruding all of the fibers together at one time as one coherent bundle. The fibers may have, for example, a round, square, or rectangular cross-section. Various embodiments herein might have described the diameter of the fiber (thus implying a round cross-section). It should be understood that, except as explicitly claimed to the contrary, other cross-sections are contemplated as within the scope of the invention. In providing an output face with an enlarged second mode, the force need merely increase the surface area of the optical fiber(s) at the output face, that surface area need not be circular.

With respect to the information display, it should be understood that a wide variety of display technologies are contemplated as within the scope of the invention. The information display could be a liquid crystal display such as a twisted nematic display, super twisted, or active matrix. Such liquid crystal displays might include glass or polymer substrates. Alternatively, the information display could be an organic light emitting diode display. The information display may be a reflective, transflective, or emissive display. The information display might include a rear backlight or frontlight utilizing a light emitting diode or electroluminescent light source. These and other refinements known to those of skill in the art herein are contemplated as within the scope of the invention.

As used herein the term elastic material is a material that can at least partially elastically deform from a first state to a second state (for example, enlarged or rotated) when force is applied, and that such deformation is not entirely plastic (and thus will preferably revert, or may be altered back to the first state). This preferably further means that the material has a glass transition temperature (T_{g}) that is below the normal operating temperature of the device (the normal operating temperature typically being room temperature). It should be understood that at least one of the core material or the cladding material is made of an elastic material. It should further be understood that it is even more preferred that both the core material and the cladding material are made of an elastic material.

To construct an elastic fiber optic image guide the underlying materials used for at least the core (and preferably also for the cladding) possess generalized properties of preferably high transmittance and preferably high elasticity. Examples of materials on the market today include, but are not limited to, elastomer, thermoplastic elastomers, polyurethanes, silicones, adhesives, and rubber. There are far fewer materials available in the market today with high optical clarity, elasticity, and lower refractive index that can be used as cladding. Such materials that could be used in the cladding include elastomers, thermoplastic elastomers, and fluoropolymers that are synthesized to have high elasticity.

One consideration in material selection is that materials that are not rigid and exhibit elasticity or softness often also have a certain amount of “tack” or tackiness on their surfaces. Tackiness is an undesirable material characteristic in that it increases the chance of materials sticking to the exterior surface(s) of the elastic fiber optic image guide. This is even more likely to occur if no protective lens cover is used and/or the external surface of the elastic fiber optic image guide is accessible to the user as part of the outside of the product casing. Tackiness might also present some difficulties in the standard process for cutting and producing a highly polished and/or substantially uniform flat optical external surface of the elastic image guide. Therefore various additives or other materials are preferably used or added. The added materials are preferably utilized in either or both the cladding and core of the optical fibers to provide an optical fiber that preferably has high light transmittance or optical clarity, high elasticity, and low tack.

Thus, embodiments of the present invention include an elastic fiber optic image guide optically coupled and/or affixed to an information display for mobile devices for at least partially selectable magnification. This might present a very complex mechanical system. There are many additional features that may preferably be employed depending on the requirements of specific product applications. The preference being to produce optimized and/or user accepted optical image quality of the information display as produced by the fiber optic image guide in both the enlarged and non-enlarged modes.

Decreased brightness is one negative optical effect that may be observed when using an elastic fiber optic image guide in a tapered mode with some degree of magnification. The elastic fiber optic image guide is coupled to an external display surface of the information display in a mobile device. One preferred embodiment to overcome any decrease in brightness when in a “stretched” mode relies on the fact that many types of information display utilized in mobile devices features either an emissive display such as an OLED or a display featuring a backlight or front light as found in many active and passive matrix LCDs. Lighting or emission means within the mobile product could be activated or further brightened when the device is in a tapered/enlarged/magnified mode. Thus, when in a magnified mode, the brightness of the emissive element of the information display is increased to compensate so the user preferably perceives no significant (and even more preferably no perceptible) decrease in brightness between the two modes. Note, however, that in mobile devices power consumption is often a major consideration. Implementation of an increased brightness in the enlarged mode is thus preferably used in conjunction with a smaller power usage when the display is not in the enlarged mode. Thus, the increase in brightness and resulting power consumption preferably occurs only when the device is being used in an enlarged or magnified state.

In producing a fiber optic image guide with elasticity that can be stretched to produce a taper or twist, there is a tradeoff between the diameter of the optical fibers in the non-stretched state and price. A larger number of fibers in an image guide requires significant additional labor and processing time to produce. Therefore the diameter and resulting surface area of the optical fibers of the image guide are optimized to provide the best image quality, but preferably at the largest optical diameter that produces such image quality to help minimize production costs. One factor that may be taken into account in this determination lies in the resolution of the human eye.

Another factor to consider relates to the optimization of the diameter or surface area of the optical fibers in the normal and the enlarged or magnified state. The degree of magnification is a function of the difference between the diameters of the optical fibers on the output face visible to a user, and those on the input face that is optically coupled (and preferably attached in some fashion) to the information display's external display surface. Theoretically, highly elastic thermoplastic elastomers or rubber-like materials might be used that can stretch up to 500% or greater without any deformation of the material when the mechanical forces are removed and it is allowed back to its non-stretched state. What may be a limiting factor in many commercial applications of embodiments of the present invention, however, is user preferences for magnification or enlargement while maintaining a clear, high quality display appearance.

For example, if the enlargement is too great the apparent resolution of the display in the enlarged state might not be aesthetically pleasing. Moreover, an increase in magnification of a fiber optic taper results in a decreasing viewing window. Standard pixel sizes for colored TFT or active matrix LCD displays presently on the market have dimensions of 0.24 mm-0.32 mm, and some are reasonably priced today with pixel dimensions as little as 0.16 mm. Over time displays are likely to offer higher resolution via smaller pixel sizes. Technology has already increased the ability to produce even smaller pixel sizes on colored TFT or active matrix LCD displays that may be as small as about 8 micron. Displays with this high resolution often find use in various LCD projectors on the market today. A further refinement of some embodiments of this invention is that information displays with smaller pixel sizes are preferably used. Use of smaller pixel sizes helps to insure that, at the desired magnification level, the display will still have an excellent high resolution appearance, and not appear too pixilated. For example, based on the pixel resolutions of reasonably priced active matrix LCDs in the market today and consumer acceptance of a “good looking” high resolution display with pixels in the range of 0.24 mm-0.32 mm, one preferred solution might be the use of a reasonably priced 0.16 mm pixel sized display and maximum magnification effect of two times (2×). In this particular embodiment the user observes pixels, when viewed in the magnified state, that appear to possess a high resolution 0.32 mm pixel size.

Another embodiment of the present invention includes options whereby the display implemented in a product may be optimized automatically or by user selection to intermediate states. That is to say, embodiments of the present invention are not limited to two modes of a “non-enlarged” 1:1 state, and a maximum enlarged or magnification state. Instead, it is contemplated as within the scope of the present invention to also permit selection of intermediate enlarged or magnified states. It should be understood that the underlying information display may use software activated automatically or via user selection to change the way that information is being displayed and what pixels are being used depending on the degree of magnification, or the difference between the 1:1 and various magnification or enlarged states. Similarly, it should be understood that the “resting state” of embodiments of the present invention need not be an unaltered 1:1 image. That is to say, it is contemplated as within the scope of the invention that the elastic fiber optic image guide may have some minimum level of force applied at all times, resulting in a slightly optically altered image in the base mode (which might be enlarged or rotated).

In another refinement the fiber optic image guide is constructed with very elastic materials. Such core materials could include but are not limited to elastomers, polyurethanes, or thermoplastic elastomers, or transparent rubber (synthetic or natural). In one embodiment the core material not only has high elasticity but also is transmissive, and is most preferably clear. The cladding material also preferably has a high elasticity. Such material also preferably has an index of refraction lower than that of the elastomeric material used in the core of the elastic optical fiber. Such materials appropriate for cladding include, but are not limited to, fluoroplastics or fluoropolymers, or specifically fluoroelastomeric materials. Companies such as 3M sell a line of fluoroplastics under the trade name Dyneon that is designed specifically for use as cladding material in optical fibers. Additives or modifications may be necessary to add to various existing fluoroplastics to give them higher elasticity and a lower durometer softness measurement, potentially with some compromise on the percentage of light transmittance.

In another refinement of this invention various modifications and additives are utilized in one or both of the selected core and cladding plastics to better match their elasticity and softness material properties. Additives may also be used to reduce the tackiness that often occurs in very soft or elastic materials. It is preferable to closely match the mechanical properties of the material being used in the cladding to that material being used in the core. This helps to insure that, in embodiments wherein the elastic fiber optic image is subjected to compression and heating to fuse the optical fibers together, there will be equal expansion of the cladding and core layers.

One of the difficulties in final assembly of an elastic fiber optic image guide involves producing a polished finish. One technique could involve cooling the material below glass transition or other very low temperature at which point the core and/or cladding materials become brittle and can be polished. Another potential technique would be to cut the ends with very high precision blades, such as diamond blades or microtomes. A final polish finishing step could involve heating the ends of the elastic fiber optic image guide and contacting them with an object with a specific shaped surface. Such a fixed surface could for example be an optical flat that can have the entire surface to ¼ to 1/20 wavelength in accuracy. Such an optically flat surface could then effectively heat and shape the ends of the elastic image to an optically flat, and polished surface. Those of ordinary skill in the art should understand that there are various ways to heat and finish the surface of the image guide. Examples include heating just the image guide or heating the optically flat or other surface, or heating both the image guide as well as the surface being used to shape the ends of the elastic fiber optic image guide.

In another refinement of this invention the ability to create a flat optical surface of the fiber could also be done by utilizing the elastic properties of the fiber itself. For an elastic fiber optic image guide that is constructed with a high elasticity it may be possible to cut a fiber generating a nearly flat surface and put a cover lens over the optical fiber. The cover lens would preferably have one surface of the cover lens in direct contact with the second end of the optical fiber. The bottom surface of the cover lens in contact with the elastic fiber would be substantially flat, and preferably optically flat. The top surface of the cover lens would be external to the consumer electronic product. The first end of the elastic fiber optic image guide could also be in direct contact with the outer surface of the display itself, and that outer surface could be substantially flat and preferably optically flat. The elastic fiber optic image guide would preferably have the individual optical fibers in the image guide conform to the flat surface of the cover lens or underlying external surface of the display, thus producing a flatter optical surface of each fiber due to their inherent conformability, and softness. This would preferably provide a substantial decrease in potential costs in polishing steps as a secondary advantage, and decrease the difficulty in trying to polish very soft, elastic materials.

In another preferred embodiment of the present invention the fiber optic image guide is constructed with materials so that it is elastic, and can be affixed to the external surface of the information display. The elastic fiber optic image guide would be able to provide a non-stretched 1:1 display image, and then expand to provide a magnified or enlarged display of the underlying display information when an external mechanical stretching or strain force is introduced either uniaxially, biaxially, or multi-axially. It should be understood that the system would also be able to exhibit various intermediate magnified or stretched states between the non-stretched state, and the maximum stretched state. It should be further understood that such intermediate states may be either at the user's selection, or automatically by software or hardware. Moreover, the external surface of the information display may be constructed with either rigid, or flexible substrates.

In another preferred embodiment means are provided to optimize the use of an elastic fiber optic image guide to produce a more uniform enlargement of the display information. Such means include, but are not limited to, centering the active display information in the portion of the elastic fiber optic image guide that will experience the most uniform response to the introduced strain, and/or constructing the elastic fiber optic image guide with fibers of varying elastic properties optimized so that when a strain is introduced the resulting optical enlargement or magnification effect would appear uniform. Other means include using a film coupled to the top external surface of the elastic fiber optic image guide where the film itself is stretched. The film is preferably designed with a gradient of elastic or mechanical properties so that the secondary stretching or strain will secondarily affect the elastic fiber optic image guide to produce a uniform optical appearance in the image now visible to the user.

In another embodiment of this patent a bezel or product casing is placed over the elastic fiber optic image guide so that only the portion of the elastic fiber optic image guide that is presenting more uniform and acceptable image quality to the user is visible. Also the means to stretch or introduce mechanical strain on the elastic fiber optic image guide may also be employed to stretch an overlaid protective lens material and also the product casing itself or user input areas. In those applications where the product casing changes in size to accommodate and/or provide uniform design aesthetic, it may be done with a telescoping effect of interleaved elements of the external product casing. Alternatively, the product casing could have specific areas that utilize a material that is capable of elastic expansion. Underlying means beneath the outer product casing may be actuated to push out or expand those areas of the product casing.

In another embodiment of this invention the resolution of the underlying information display is preferably optimized to that of the resolution of the elastic fiber optic image guide in both its non-stretched and stretched states. As discussed previously with reference to FIG. 10, a software based optimization could be employed to change the information displayed depending on whether the unit is operating in a non-stretched 1:1 state or a stretched or magnified image state. Again, as previously noted, the base state might instead include some slight magnification or rotation based on desired commercial implementation. In another refinement of this invention the varied elongation and resulting magnification of various areas of the optical fiber in its second or stretched state are measured. The varying magnification effects are then used in software to modify the image content that is produced and displayed. The image content is modified in such a way to take advantage of the larger screen size produced by the elastic image guide when in a second or magnification state, but preferably modified to insure it appears to the user that there is substantially uniform magnification of the image content. The software may have an algorithm configured internally to dynamically vary all of the information content to be displayed to adjust for the irregular but larger image surface. The mobile device may also have the individual screen content preconfigured with image content stored internally for each screen for a non-stretched, first display state that will typically be on the order of 1:1. The second content for each screen is preferably modified to take into consideration any irregularities in the magnified image and screen size. That is to say, the stored image content is preferably modified to produce display content that, when viewed through the elastic image guide in a second stretched or magnification state, will appear to produce a more uniform, magnified display content to the user.

While the invention has been illustrated and described in detail in the drawings and foregoing description, the same is to be considered illustrative and not restrictive in character, it being understood that only the preferred embodiment has been shown and described and that all changes and modifications that come within the spirit of the invention are desired to be protected.

1. An apparatus comprising:
a fiber optic image guide comprising a plurality of optical fibers, each optical fiber comprising a core material and a cladding material, wherein at least one of the core material and the cladding material is elastic at room temperature.

2. The apparatus of claim 1, wherein both the core material and the cladding material are elastic at room temperature.

3. The apparatus of claim 1, wherein the at least one of the core material and the cladding material is selected from a group consisting of a polymer, thermoplastic elastomer, fluoropolymer, rubber or silicone.

4. The apparatus of claim 1, wherein the at least one of the core material and the cladding material has a glass transition temperature below room temperature.

5. The apparatus of claim 1, wherein at least a portion of the plurality of optical fibers extend between an input face and an output face of the fiber optic image guide, the fiber optic image guide having a first mode in which no force is applied to the output face and a second mode in which the output face of the fiber optic image guide is at least partially elastically deformed by a force, and wherein a second output image formed on the output face in the second mode is optically different than a first output image formed on the output face in the first mode.

6. The apparatus of claim 5, wherein the first output image is substantially the same as an input image present at the input face.

7. The apparatus of claim 5, wherein at least a portion of the second output image is magnified compared to a corresponding portion of the first output image.

8. The apparatus of claim 5, wherein a surface area of one of the plurality of optical fibers at the output face in the second mode is greater than the surface area of the one of the plurality of optical fibers at the output face in the first mode.

9. The apparatus of claim 5, wherein at least a portion of the output image in the second mode is rotated with respect to at least a portion of the input image present at the input face.

10. A fiber optic image guide comprising a plurality of optical fibers extending between an input face and an output face, each optical fiber comprising a core material and a cladding material, wherein at least one of the core material and the cladding material is not rigid.

11. The apparatus of claim 10, wherein at least a portion of the plurality of optical fibers extend between an input face and an output face of the fiber optic image guide, the fiber optic image guide having a first mode in which no force is applied to the output face and a second mode in which the output face of the fiber optic image guide is at least partially elastically deformed, a second output image formed on the output face in the second mode being optically different than a first output image formed on the output face in the first mode.

12. The apparatus of claim 11, wherein the first output image is substantially the same as an input image present at the input face.

13. The apparatus of claim 12, wherein at least a portion of the second output image is magnified compared to a corresponding portion of the first output image.

14. The apparatus of claim 12, wherein at least a portion of the second output image is rotated compared to the first output image.

15. An apparatus comprising:
an information display having an external display surface; and,
a fiber optic image guide having a plurality of optical fibers extending between an input face and an output face, the input face of the fiber optic image guide being optically coupled to the external display surface of the information display, the output face being at least partially elastically deformable from a first state to a second state, wherein the output face has a larger surface area in the second state than in the first state.

16. The apparatus of claim 15, wherein the information display is a liquid crystal display.

17. The apparatus of claim 16, wherein the liquid crystal display is selected from a group consisting of: twisted-nematic, super twisted nematic, active matrix, liquid crystal on silicon, or an organic light emitting polymer display.

18. The apparatus of claim 16, wherein the information display and fiber optic image guide are part of a mobile device, the output face of the fiber optic image guide providing a first non-magnified image of the information display in the first state, and wherein the output face of the fiber optic image guide provides a second at least partially enlarged image of the information display in the second state.

19. The apparatus of claim 18, wherein the mobile device is a mobile phone.

20. The apparatus of claim 18, wherein the mobile device is a watch.

21. The apparatus of claim 17, wherein both the core material and the cladding material are elastic at room temperature.

22. The apparatus of claim 16, wherein the apparatus has a first mode in which no force is applied to the output face and a second mode in which the output face of the fiber optic image guide is at least deformed by a force, and wherein a second output image formed on the output face in the second mode is magnified when compared to a first output image formed on the output face in the first mode.

23. The apparatus of claim 22, further comprising a substantially transparent film affixed to at least a portion of the output face of the fiber optic image guide.

24. The apparatus of claim 22, wherein the plurality of optical fibers have varying elasticity properties to compensate for distortion in the second mode and provide more uniform magnification in the second mode.

25. A mobile device comprising
a power source;
a microprocessor electrically connected to the power source;
an information display with an external display surface, the information display being electrically connected to the microprocessor;
a fiber optic image guide having a plurality of optical fibers extending between an input face and an output face, the input face of the fiber optic image guide being optically coupled to the external display surface of the information display, the output face of the fiber optic image guide being deformable from a first state to a second state.

26. The mobile device of claim 25, wherein the deformation of at least a portion of the output face from the first state to the second state results in increased surface area of the output face in the second state, the information display generating an input image to the input face of the fiber optic image guide, and wherein a second output image at the output face of the fiber optic image guide is at least partially magnified in the second state when compared to a first output image in the first state.

27. The mobile device of claim 26, wherein the second output image produced at the output face of the fiber optic image guide in the second state includes non-uniform magnification, and wherein the microprocessor controls the information display to generate an altered input image so that the second output image at the output face of the fiber optic image guide appears to have a more uniform magnification.

28. The mobile device of claim 27, wherein the information display generates an altered input image that is configured to at least partially counter an aberration created by the fiber optic image guide in its second state, and wherein the altered input image includes a counter-distortion relative to the input image in the first state that is configured to least partially counter a distortion in the fiber optic image guide in the second state.

29. The apparatus of claim 25, wherein the information display is a liquid crystal display, and wherein the output face of the fiber optic image guide has a larger surface area in the second state then in the first state.

30. The apparatus of claim 29, wherein the mobile device is a mobile phone.

31. The apparatus of claim 29, wherein each of the plurality of optical fibers comprises a core material and a cladding material, and wherein at least one of the core material and the cladding material is elastic at room temperature.

32. A method of operating a mobile device between a first mobile mode and a second usage mode, comprising:
providing a fiber optic image guide having a plurality of optical fibers extending between an input end and an output end, each of the plurality of optical fibers comprising a core material and a cladding material, wherein at least a portion of the plurality of optical fibers having at least one of the core material and the cladding material being elastic at operating temperature, and wherein the input end of the fiber optic image guide is optically coupled to an external display surface of an information display of the mobile device; and
at least partially elastically deforming the output end of the fiber optic image guide between a first state and a second state, wherein a second output image formed at the output end in the second state is optically different than a first output image formed on the output end in the first state.

33. The method of claim 32, wherein the deforming includes applying a force to at least a portion of the output face when the fiber optic image guide is at an operating temperature greater than a glass transition temperature of at least one of the core material and the cladding material.

34. The method of claim 32, wherein the deforming is rotating the output end with respect to the input end.

35. The method of claim 32, wherein the deforming is stretching at least a portion of the output end.
